(19) United States
(12) Patent Application Publication
(10) Pub. No.: US 2026/0332985 A1
(43) Pub. Date: Oct. 22, 2026

(54) COMMUNICATION METHOD AND APPARATUS, AND STORAGE MEDIUM

(71) Applicant: Beijing Xiaomi Mobile Software Co., Ltd., Beijing (CN)

(72) Inventor: Yi XIONG, Beijing (CN)

(73) Assignee: Beijing Xiaomi Mobile Software Co., Ltd., Beijing (CN)

(21) Appl. No.: 19/116,878

(22) PCT Filed: Sep. 29, 2022
(86) PCT No.: PCT/CN2022/122830

§ 371 Date: Mar. 28, 2025

(51) Int. Cl. H04W 4/02

(52) U.S. Cl. CPC H04W 4/027

(57) ABSTRACT

The present disclosure relates to a communication method and apparatus, and a storage medium. The method comprises: determining configuration information, the configuration information comprising information for triggering a terminal to perform a communication behavior on the basis of a mobility event; and executing the communication behavior on the basis of the configuration information. In the present disclosure, according to the configuration information for triggering the terminal to perform the communication behavior on the basis of the mobility event, the terminal can execute the communication behavior, so that a network device performs mobile configuration and optimization, thereby reducing the probabilities of a handover failure and a radio link failure, and improving the mobility performance of the terminal.

### CROSS REFERENCE TO RELATED APPLICATION

The present application is a U.S. National Stage of International Application No. PCT/CN2022/122830, filed on Sep. 29, 2022, the contents of which are incorporated herein by reference in its entirety.

### TECHNICAL FIELD

The present disclosure relates to the technical field of communication, particularly to a communication method and apparatus and a storage medium.

### BACKGROUND

In the related art, some terminals may currently perform measurement reporting or a conditional handover based on the fulfilling of a specific event. For example, when a height value of a terminal fulfills a certain condition, the terminal's measurement reporting is started or the terminal performs a conditional handover.

For example, for some special terminals, such as uncrewed aerial vehicles (UAVs), interest in UAV-based services has increased dramatically worldwide in recent years, including operations of various UAVs, personal entertainment through flight experience, cargo delivery, etc. As the basis of these services, remote control and data transmission capabilities are key aspects of enhancement, which are also of interest to service providers, operators, and UAV manufacturers.

The feasibility and required enhancements of UAV connection through a terrestrial cellular system have been verified in related research. In Long Term Evolution (LTE), corresponding enhancements have been made to uplink (UL) and downlink (DL) interference and mobility.

In LTE UAV, the mobility performance of UAV User Equipment (UE) is seriously affected as the moving velocity of the UAV UE changes. Especially, New Radio (NR) UAV UE has very high requirement for service continuity, which seriously affects the mobility performance and service continuity of UAV UE.

### SUMMARY

In order to overcome the problem existing in the related art, the present disclosure provides a communication method and apparatus and a storage medium.

According to a first aspect of an embodiment of the present disclosure, a communication method is provided. The method is applied to a terminal. The method includes: determining configuration information, wherein the configuration information includes information for triggering a terminal to perform a communication behavior based on a mobility event; and performing the communication behavior based on the configuration information.

According to a second aspect of an embodiment of the present disclosure, a communication method is provided. The method is applied to a network device. The method includes: sending configuration information, wherein the configuration information includes information for triggering a terminal to perform a communication behavior based on a mobility event.

According to a third aspect of an embodiment of the present disclosure, a communication apparatus is provided. The apparatus is configured in a terminal. The apparatus includes: a determination module configured to determine configuration information, wherein the configuration information includes information for triggering a terminal to perform a communication behavior based on a mobility event; and an execution module configured to perform the communication behavior based on the configuration information.

According to a fourth aspect of an embodiment of the present disclosure, a communication apparatus is provided. The apparatus is configured in a network device. The apparatus includes: a sending module configured to send configuration information, wherein the configuration information includes information for triggering a terminal to perform a communication behavior based on a mobility event.

According to a fifth aspect of an embodiment of the present disclosure, a communication apparatus is provided. The apparatus includes: a processor; and a memory configured to store instructions executable by the processor; wherein the processor is configured to perform the method in the first aspect.

According to a sixth aspect of an embodiment of the present disclosure, a communication apparatus is provided. The apparatus includes: a processor; and a memory configured to store instructions executable by the processor; wherein the processor is configured to perform the method in the second aspect.

According to a seventh aspect of an embodiment of the present disclosure, a non-transitory computer-readable storage medium is provided. When instructions in the storage medium are executed by a processor of a terminal, the terminal is caused to perform any one of the methods in the first aspect.

According to an eighth aspect of an embodiment of the present disclosure, a non-transitory computer-readable storage medium is provided. When instructions in the storage medium are executed by a processor of a network device, the network device is caused to perform any one of the methods in the second aspect.

It is to be understood that the foregoing general description and the following detailed description are illustrative and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the specification, serve to explain the principles of the present disclosure.

FIG. 1 is a schematic diagram of a wireless communication system according to an example embodiment.

FIG. 2 is a schematic diagram of a measurement indication process according to an example embodiment.

FIG. 3 is a flowchart of a communication method according to an example embodiment.

FIG. 4 is a flowchart of another communication method according to an example embodiment.

FIG. 5 is a flowchart of yet another communication method according to an example embodiment.

FIG. 6 is a flowchart of yet another communication method according to an example embodiment.

FIG. 7 is a flowchart of another communication method according to an example embodiment.

FIG. 8 is a flowchart of yet another communication method according to an example embodiment.

FIG. 9 is a flowchart of yet another communication method according to an example embodiment.

FIG. 10 is a flowchart of another communication method according to an example embodiment.

FIG. 11 is a flowchart of yet another communication method according to an example embodiment.

FIG. 12 is a schematic diagram of a communication apparatus according to an example embodiment.

FIG. 13 is a schematic diagram of another communication apparatus according to an example embodiment.

FIG. 14 is a schematic diagram of yet another communication apparatus according to an example embodiment.

FIG. 15 is a schematic diagram of yet another communication apparatus according to an example embodiment.

### DETAILED DESCRIPTION

Here, example embodiments will be described in detail, examples of which are shown in the accompanying drawings. When the following description refers to the drawings, the same numbers in different drawings represent the same or similar elements, unless otherwise indicated. The implementations described in the following example embodiments do not represent all implementations consistent with the present disclosure.

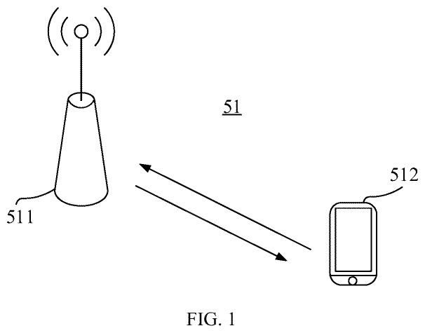

The communication methods involved in the present disclosure may be applied to a wireless communication system 51 shown in FIG. 1. The network system may include network device(s) 511 and terminal(s) 512. It can be understood that the wireless communication system shown in FIG. 1 is only for schematic illustration, and the wireless communication system may also include other network device(s), for example, a core network device, a wireless relay device, and a wireless backhaul device and so on, which are not shown in FIG. 1. The embodiments of the present disclosure do not limit the number of network device(s) and terminal(s) included in the wireless communication system.

It can be further understood that the wireless communication system of the embodiments of the present disclosure is a network that provides wireless communication function(s). The wireless communication system may adopt different communication technologies, such as Code Division Multiple Access (CDMA), Wideband Code Division Multiple Access (WCDMA), Time Division Multiple Access (TDMA), Frequency Division Multiple Access (FDMA), Orthogonal Frequency-Division Multiple Access (OFDMA), Single Carrier FDMA (SC-FDMA), Carrier Sense Multiple Access with Collision Avoidance. According to factors of different networks such as capacity, rate, or delay, the network may be divided into a 2G (Generation) network, a 3G network, a 4G network or a future evolved network, such as the 5th Generation Wireless Communication System (5G) network, and the 5G network may also be called a New Radio (NR) network. For the convenience of description, the present disclosure sometimes refers to the wireless communication network as a network for short.

Furthermore, the network device involved in the present disclosure may also be referred to as a wireless access network device. The wireless access network device may be: a base station, an evolved Node B (eNB), a home base station, an Access Point (AP) in a Wireless Fidelity (WiFi) system, a wireless relay node, a wireless backhaul node or a Transmission Point (TP), etc., or may also be a gNB in the NR system, or may also be a component or part of a device constituting a base station. When it is a vehicle-to-everything (V2X) communication system, the network device may also be a vehicle-mounted device. It should be understood that in the embodiments of the present disclosure, the specific technology and specific device form adopted by the network device are not limited.

Furthermore, the terminal involved in the present disclosure may also be referred to as a terminal device, User Equipment (UE), Mobile Station (MS), Mobile Terminal (MT), etc., which is a device that provides voice and/or data connectivity to user(s). For example, the terminal may be a handheld device with a wireless connection function, a vehicle-mounted device, etc. At present, some examples of the terminal are: a smart phone (Mobile Phone), a Pocket Personal Computer (PPC), a handheld computer, a Personal Digital Assistant (PDA), a laptop, a tablet computer, a wearable device, or a vehicle-mounted device, etc. In addition, when it is a vehicle-to-everything (V2X) communication system, the terminal device may also be a vehicle-mounted device. It should be understood that the embodiments of the present disclosure do not limit the specific technology and specific device form adopted by the terminal.

In the embodiments of the present disclosure, the network device and the terminal may use any feasible wireless communication technology to achieve mutual data transmission. A transmission channel corresponding to the network device sending data to the terminal is called a downlink (DL) channel, and a transmission channel corresponding to the terminal sending data to the network device is called an uplink (UL) channel. It can be understood that the network device involved in the embodiments of the present disclosure may be a base station. Of course, the network device may also be any other possible network device, and the terminal may be any possible terminal, which is not limited by the present disclosure.

In related art, measurement reporting or a conditional handover of the UAV UE is limited to being triggered only when the height value fulfills a certain condition. Obviously, the impact of the UAV UE moving velocity on the mobility performance is not considered.

In a mobile communication system, the movement of a UE causes the channel state around the UE to change all the time. In order to support the mobility of the UE, the channel state(s) of cell(s) around the UE is(are) obtained in time. The network device configures the UE to perform Radio Resource Management (RRM) measurement(s). UEs in an idle state and an inactive state autonomously perform cell selection or cell reselection based on RRM measurement result(s). A UE in a connected state reports a RRM measurement result to the network device to assist the network device in making handover decisions. During the measurement procedure of the UE in the connected state, the network of the NR system sends measurement configuration information to the UE in the connected state through Radio Resource Control (RRC) signalling. The UE performs intra-frequency/inter-frequency/inter-system measurement based on the content of the measurement configuration information, and then reports a measurement result to the network device. The measurement may be divided into three aspects: measurement configuration, measurement execution, and measurement reporting.

The inter-system may indicate different Radio Access Technology (RAT) systems.

Regarding measurement configuration, the network device uses an RRC reconfiguration procedure to perform measurement configuration. The measurement configuration information may include information such as: measurement object(s), reporting configuration(s), measurement identity(identities), measurement start threshold(s), measurement gap(s), and measurement gap assignment(s).

Each set of measurement(s) is associated and configured in an indexed manner, with the total index being a measurement identity. All measurement(s) is(are) arranged in full accordance with the association relationship with the measurement identity and is(are) sent to the UE by the network device. Each measurement identity is simultaneously linked to a measurement object identity and a reporting configuration identity, indicating that the measurement object for which a measurement is needed and the reporting configuration are combined. The network device may also send to the UE measurement object(s) and reporting configuration(s) that are not linked to measurement identity(identities), but the UE does not perform any form of measurement for the configuration(s). It should be noted that each measurement identity can only be associated with one measurement object identity and one reporting configuration identity.

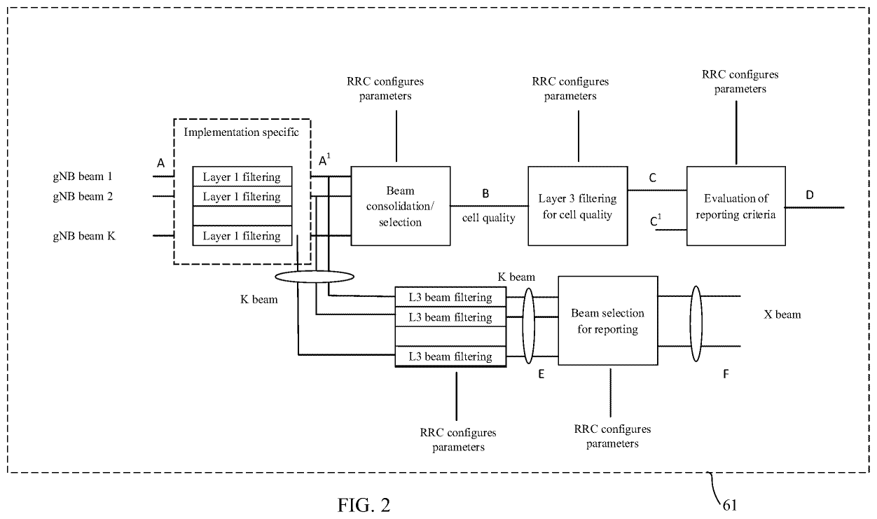

Regarding measurement execution, for example, FIG. 2 is a schematic diagram of a measurement indication process 61 according to an example embodiment. The corresponding high-level measurement model is described as follows:

It should be noted that K beams correspond to measurements on Synchronization Signal Block (SSB) or Channel State Information-Reference Signal (CSI-RS) resources configured for L3 mobility by the gNB and detected by the UE at L1.
A: measurements (beam specific samples) internal to the physical layer.
Layer 1 filtering: internal Layer 1 filtering of the inputs measured at point A. Exact filtering is implementation dependent. How the measurements are actually executed in the physical layer by an implementation (inputs A and Layer 1 filtering) is not constrained by the standard.
A¹: measurement values (i.e. beam specific measurement values) reported by Layer 1 to Layer 3 after Layer 1 filtering.
Beam consolidation/selection: beam specific measurements are consolidated to derive cell quality. The behavior of the beam consolidation/selection is standardized and the configuration of this module is provided by RRC signalling. The reporting period at B equals one measurement period at A¹.
B: a measurement value (i.e., cell quality) derived from beam-specific measurement values reported to Layer 3 after beam consolidation/selection.
Layer 3 filtering for cell quality: filtering performed on the measurements provided at point B. The behavior of the Layer 3 filters is standardized and the configuration of the Layer 3 filters is provided by RRC signalling. The filtering reporting period at C equals one measurement period at B.

C: a measurement value after processing in the Layer 3 filter. The reporting rate is identical to the reporting rate at point B. This measurement is used as input for one or more evaluations of the reporting criteria.
Evaluation of reporting criteria: checks whether actual measurement reporting is necessary at point D. The evaluation can be based on more than one flow of measurements at reference point C, e.g., to compare between different measurement values. This is illustrated by inputs C and C¹. The UE shall evaluate the reporting criteria at least every time a new measurement result is reported at point C, C¹. The reporting criteria are standardized and the configuration is provided by RRC signalling (UE measurements).
D: measurement report information (message) sent on the radio interface.
L3 beam filtering: filtering performed on the measurements (i.e. beam specific measurements) provided at point A¹. The behavior of the beam filters is standardized and the configuration of the beam filters is provided by RRC signalling. The filtering reporting period at E equals to one measurement period at A¹.
E: a measurement (i.e. a beam-specific measurement) after processing in the beam filter. The reporting rate is identical to the reporting rate at point A¹. This measurement is used as input for selecting the X measurement to be reported.
Beam selection for beam reporting: selects the X measurement values from the measurement values provided at point E. The behavior of beam selection is standardized and the configuration of this module is provided by RRC signalling.
F: beam measurement information included in the measurement report (sent) on the radio interface.

Of course, for the implementation of a more specific measurement execution procedure, reference may be made to related art, and will not be described in detail in the present disclosure.

Regarding measurement reporting, the UE performs a measurement according to the measurement configuration sent by the network device, and reports the evaluation of criterion after obtaining a cell-level measurement result. Generally speaking, measurement reporting can be divided into event-triggered reporting and periodic reporting according to the evaluation of reporting criterion. The adopted evaluation of reporting criterion is determined by the reporting configuration sent to the UE.

For example, regarding the event-triggered reporting, the RRM events supported in the current NR system include A1, A2, A3, A4, A5, A6, and B1 and B2 event for inter-RAT. The six measurement events of the same system are described as follows.
Event A1: a measurement result of a serving cell is greater than a threshold;
Event A2: a measurement result of a serving cell is smaller than a threshold2;
Event A3: a measurement result of a neighboring cell is better than a measurement result of a special cell (SpCell);
Event A4: a measurement result of a neighboring cell is greater than a threshold3;
Event A5: a measurement result of a SpCell is smaller than a threshold4, and meanwhile a measurement result of a neighboring cell is greater than a threshold5;
Event A6: a measurement result of a neighboring cell is better than a measurement result of a secondary serving cell (SCell).

The SpCell may be a primary serving cell (primary cell, PCell) or a primary secondary serving cell (primary secondary cell, PSCell).

The inter-RAT measurement events currently supported by the NR system are described as follows.
Event B1: a measurement result of a neighboring inter-RAT cell is greater than a threshold;
Event B2: a measurement result of a primary serving cell (PCell) is smaller than a threshold6, and meanwhile a measurement result of a neighboring inter-RAT neighboring cell is greater than a threshold 7.

The event-triggered reporting can be further divided into event-triggered one-time reporting and event-triggered periodic reporting. When an event triggers one-time reporting, the UE triggers sending of a measurement report only when it is fulfilled that a measurement event configured by the network enters a threshold and lasts for a time period. The process ends after the measurement report is sent once. The reporting configuration corresponding to this criterion is:
The trigger type is “event”, including one of measurement events from A1 to A6 or B1 to B2 and its threshold parameter(s);
The number of time(s) of reporting is equal to 1;
Regardless of the configured value of the reporting interval, the UE ignores it.

Event-triggered periodic reporting is a combination of event-triggered reporting and periodic reporting. The UE triggers sending of a measurement report only when it is fulfilled that a measurement event configured by the network enters a corresponding threshold and lasts for a time period. After the reporting is triggered, a timer between multiple measurements and a counter for counting the number of measurements are turned on until the number of time(s) of reporting reaches the requirement and the process ends. The reporting configuration corresponding to this criterion is:
The trigger type is “event”, including one of measurement events from A1 to A6 or B1 to B2 and its threshold parameter(s);
The number of time(s) of reporting is greater than 1;
The reporting interval is valid, and the network sets the reporting periodic timer according to the configured interval parameter.

For the periodic reporting method, after the measurement configuration of the network device is completed, the UE measures corresponding frequency point(s) according to the content of the configuration, and send the measurement report according to the specified reporting period and interval. If the trigger type is “periodic”, when the maximum number of time(s) of reporting is reached, the UE autonomously deletes a corresponding measurement identity in the measurement configuration variable. The reporting configuration corresponding to this criterion is:
The trigger type is “periodic”;
The number of time(s) of reporting is greater than 1;
The reporting interval is valid, and the network sets the reporting periodic timer according to the configured interval parameter.

In addition to the above two conventional measurement reporting types, one-time measurement trigger reporting is introduced for some special use cases, including one-time measurement trigger reporting introduced to support the Automatic Neighbor Relationship (ANR) function, which is used to trigger a UE to obtain relevant information of a specific cell and trigger one-time measurement reporting. The relevant information of the specific cell may include information such as, a cell global identity, the Tracking Area Code (TAC) to which the cell belongs, the Public Land Mobile Network (PLMN) list to which the cell belongs, and so on.

If a reporting condition is fulfilled, the UE triggers the reporting of a measurement report. The content of the measurement report may include the following aspects:
\textcircled{1} Measurement identity: through this identity, the network device obtains various information from the measurement configuration stored in the network device itself, including content such as the measurement object corresponding to the current reporting, the measurement event threshold triggered by the event, the purpose of the periodic trigger, etc.
\textcircled{2} All available serving cell measurement result(s).
\textcircled{3} According to the reporting configuration, the best neighboring cell measurement result on each service frequency may be optionally carried.

\textcircled{4} Measurement result(s) of neighboring cell(s) that fulfills(fulfill) a trigger condition.

In recent years, the global interest in UAV-based services has increased dramatically, including operations of a variety of UAVs, personal entertainment through flight experience, cargo delivery, etc. As the basis of these services, remote control and data transmission capabilities are key aspects of enhancement, which are also of interest to service providers, operators and UAV manufacturers.

In the related art, for example, the researches on UAV were conducted in release 15. According to these researches, the feasibility and required enhancements of uav connection through a terrestrial cellular system have been verified. The LTE has made corresponding enhancements in UL and DL interference and mobility.

For example, height-based measurement reporting events and height reporting are introduced in LTE UAV:
Event H1 (UE height is greater than a threshold);
Event H2 (UE height is smaller than a threshold);

In NR, the applications suitable for UAV are more diverse, and the UAV terminals have requirements of lower latency of and requirements of transmission rate. Therefore, NR UAV needs to be enhanced based on LTE UAV.

However, the mobility of a UAV UE is not only affected by the height of the UAV UE. Related studies have shown that the mobility performance of a UAV UE is affected by the movement velocity. The mobility performance may include, for example: the number of serving cell handover(s), the number of Radio Link Failure(s) (RLF(s)), and the proportion of being greater than the out-of-sync threshold (Qout). When the movement velocity increases, the handover frequency of the UAV UE increases, the occurrence rate of RLF increases, and the proportion of out-of-sync increases. This seriously affects the performance and service continuity of the UAV UE. Especially, a NR UAV UE has a higher requirement for service connectivity.

However, the current measurement reporting or a conditional handover of a UAV UE is limited to being triggered only when a certain condition is fulfilled based on a height value, and does not take into account the impact of the movement velocity. The movement velocity has a much greater impact on the UAV UE than on a ground UE. This is because the UAV UE flies at a high height, resulting in more Line of Sight (Los) paths, and too fast movement velocity, especially the change in vertical velocity, will cause the interference imposed in the channel environment of the UAV UE to change rapidly. Accordingly, the handover rate, RLF rate, or rate of out-of-sync is increased.

Obviously, the impact of terminal movement velocity on the mobility performance is not currently taken into account.

Therefore, the present disclosure provides a communication method, which can enable a terminal to perform a communication behavior based on configuration information that triggers the terminal to perform the communication behavior based on a mobility event. In this way, a network device can perform mobile configuration and optimization, thereby reducing the probability of handover failure or radio link failure, and improving the mobility performance of the terminal.

FIG. 3 is a flowchart of a communication method according to an example embodiment. As shown in FIG. 3, the method may be applied to a terminal. The method may include the following steps:

In step S11, configuration information is determined.

In some embodiments, the terminal may determine configuration information. The configuration information includes information for triggering the terminal to perform a communication behavior based on a mobility event.

For example, the configuration information may be pre-configured in the terminal, and the terminal determines the pre-configured configuration information. For another example, the terminal may receive configuration information sent by other device. It is understood that the other device may be any device other than the terminal, and the present disclosure does not limit this.

In step S12, the communication behavior is performed based on the configuration information.

In some embodiments, the terminal may perform a corresponding communication behavior based on the configuration information determined in S12.

For example, the terminal triggers the communication behavior based on the mobility event according to the configuration information.

The present disclosure can enable the terminal to perform the communication behavior based on the configuration information that triggers the terminal to perform the communication behavior based on the mobility event. In this way, the network device can perform mobile configuration and optimization, thereby reducing the probability of handover failure or radio link failure, and improving the mobility performance of the terminal.

In the communication method provided by the embodiment of the present disclosure, the mobility event is a velocity-based mobility event.

In some embodiments, the mobility event that triggers the terminal to perform the communication behavior may be the velocity-based mobility event.

It can be understood that the present disclosure takes into account the impact of velocity on the terminal, and thus a velocity-based mobility event can trigger the terminal to perform the communication behavior.

In the present disclosure, the terminal is triggered to perform the communication behavior in combination with the velocity-based mobility event, so that network device can perform mobile configuration and optimization, thereby reducing the probability of handover failure or radio link failure, and improving the mobility performance of the terminal.

In the communication method provided by the embodiments of the present disclosure, the velocity-based mobility event may include at least one of: a velocity of the terminal being greater than a first velocity threshold; the velocity of the terminal being smaller than a second velocity threshold; a velocity change amount of the terminal being greater than a velocity change amount threshold; or a height change amount of the terminal being greater than a height change amount threshold.

In some embodiments, the velocity-based mobility event may be the velocity of the terminal being greater than the first velocity threshold.

For example, the terminal may be triggered to perform the communication behavior based on the velocity of the terminal being greater than the first velocity threshold. Of course, the velocity of the terminal may be a vertical velocity or a horizontal velocity.

In some embodiments, the velocity-based mobility event may be the velocity of the terminal being smaller than the second velocity threshold.

For example, the terminal may be triggered to perform the communication behavior based on the velocity of the terminal being smaller than the second velocity threshold. Of course, the velocity of the terminal may be a vertical velocity or a horizontal velocity.

In some embodiments, the velocity-based mobility event may be the velocity change amount of the terminal being greater than the velocity change amount threshold.

For example, the terminal may be triggered to perform the communication behavior based on the velocity change amount of the terminal being greater than the velocity change amount threshold. Of course, the velocity change amount of the terminal may be a vertical velocity change amount or a horizontal velocity change amount.

In some embodiments, the velocity-based mobility event may be the height change amount of the terminal being greater than the height change amount threshold.

For example, the terminal may be triggered to perform the communication behavior based on the height change amount of the terminal being greater than the height change amount threshold. It can be understood that the height change in the terminal may indirectly reflect the change in the terminal velocity. For example, in combination with time information, when the height change amount of the terminal is large within a time period, it can be considered that the terminal may descend or rise rapidly. Therefore, the height change amount of the terminal may be used as an implicit indication of the terminal velocity.

The present disclosure provides a variety of different velocity-based mobility events, so that the terminal can trigger the communication behavior based on the velocity-based mobility event(s) in different scenarios, so that network device can perform mobile configuration and optimization, thereby reducing the probability of handover failure or radio link failure, and improving the mobility performance of the terminal.

In the communication method provided by the embodiment of the present disclosure, the velocity-based mobility event may include at least one of: a vertical velocity of the terminal being greater than a first vertical velocity threshold; the vertical velocity of the terminal being smaller than a second vertical velocity threshold; a vertical velocity change amount of the terminal being greater than a vertical velocity change amount threshold; or a height change amount of the terminal being greater than a height change amount threshold.

In some embodiments, the velocity-based mobility event may be the vertical velocity of the terminal being greater than the first vertical velocity threshold.

For example, the terminal may be triggered to perform the communication behavior based on the vertical velocity of the terminal being greater than the first vertical velocity threshold.

In some embodiments, the velocity-based mobility event may be the vertical velocity of the terminal being smaller than the second vertical velocity threshold.

For example, the terminal may be triggered to perform the communication behavior based on the vertical velocity of the terminal being smaller than the second vertical velocity threshold.

In some embodiments, the velocity-based mobility event may be the vertical velocity change amount of the terminal being greater than the vertical velocity change amount threshold.

For example, the terminal may be triggered to perform the communication behavior based on the vertical velocity change amount of the terminal being greater than the vertical velocity change amount threshold.

In some embodiments, the velocity-based mobility event may be the height change amount of the terminal being greater than the height change amount threshold.

For example, the terminal may be triggered to perform the communication behavior based on the height change amount of the terminal being greater than the height change amount threshold.

The present disclosure provides a variety of different mobility events based on the vertical velocity, so that the terminal can trigger the communication behavior based on velocity-based mobility event(s) in different scenarios, so that the network device can perform mobile configuration and optimization, thereby reducing the probability of handover failure or radio link failure, and improving the mobility performance of the terminal.

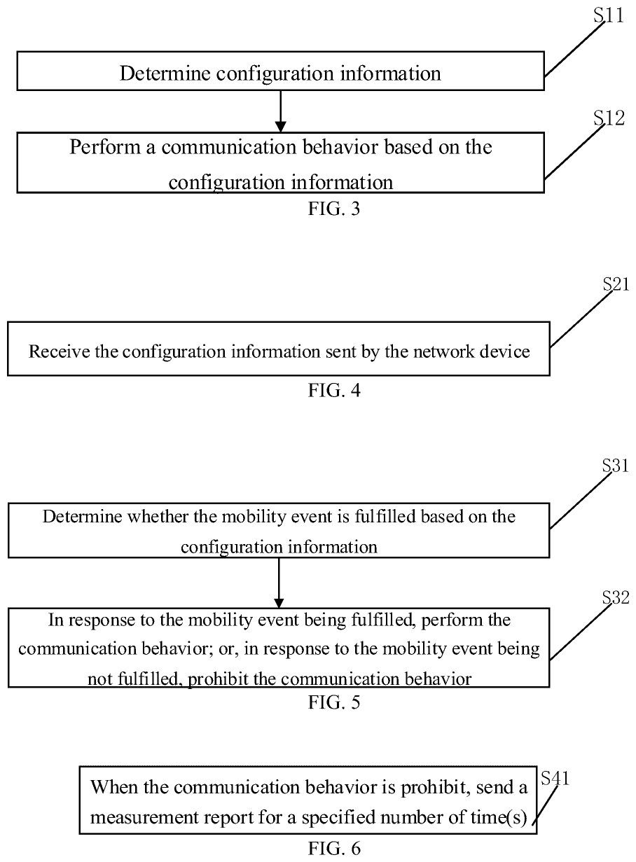

In the communication method provided in an embodiment of the present disclosure, FIG. 4 is a flowchart of another communication method according to an example embodiment. As shown in FIG. 4, determining the configuration information in S11 may include the following step(s):

In step S21, the configuration information sent by a network device is received.

In some embodiments, the terminal may receive the configuration information sent by the network device.

For example, the configuration information may be configured by the network device and sent to the terminal after the configuration is completed. The terminal receives the configuration information sent by the network device so as to perform the communication behavior according to the configuration information.

In the present disclosure, the terminal is triggered to perform the communication behavior based on the mobility event by receiving the configuration information sent by the network device, so that the network device performs mobile configuration and optimization, thereby reducing the probability of handover failure or radio link failure, and improving the mobility performance of the terminal.

In the communication method provided by the embodiment of the present disclosure, the configuration information includes at least one of the following information: event type information, where the event type information is used to indicate the mobility event that triggers the terminal to perform the communication behavior; a threshold for triggering the terminal to perform the communication behavior based on the mobility event; time information for triggering the terminal to perform the communication behavior based on the mobility event; a hysteresis value for triggering the terminal to perform the communication behavior based on the mobility event; or reporting indication information for fulfilling measurement reporting for the mobility event.

In some embodiments, the configuration information includes the event type information.

For example, the configuration information may include the event type information to describe the mobility event that triggers the terminal to perform the communication behavior. It is understandable that the event type information may include an identity of an event, such as event S1, event S2, event S3, etc. In such a case, it is possible to pre-define which events correspond to different identities, for example, event SI corresponds to “the velocity of the terminal being greater than the first velocity threshold”, event S2 corresponds to “the velocity of the terminal being smaller than the second velocity threshold”, etc. Of course, the event type information may also be directly information describing the event, such as “the velocity of the terminal being greater than the first velocity threshold”, “the vertical velocity of the terminal being greater than the first vertical velocity threshold”, etc. The terminal may determine which mobility event(s) triggers(trigger) the terminal to perform the communication behavior based on the event type information.

In some embodiments, the configuration information includes the threshold for triggering the terminal to perform the communication behavior based on the mobility event.

For example, the configuration information may include the threshold for triggering the terminal to perform the communication behavior based on the mobility event. Different mobility events correspond to corresponding thresholds. The terminal may be triggered to perform the communication behavior when a relationship between a corresponding parameter and a threshold fulfills a condition for a corresponding event. For example, when the threshold is the first velocity threshold, the terminal may be triggered to perform the communication behavior when the velocity of the terminal being greater than the first velocity threshold is fulfilled.

In some embodiments, the configuration information includes time information for triggering the terminal to perform the communication behavior based on the mobility event. For example, the configuration information may include the time information for triggering the terminal to perform the communication behavior based on the mobility event. It is understandable that the time information may be used to describe the time for the terminal to trigger execution of the communication behavior based on the mobility event. For example, the time information is: X (hours):X (minutes): on XX day. It can indicate that the terminal may be triggered to perform the communication behavior based on the mobility event after this time point. Alternatively, the time information is a time period, such as, X1 (hours):X1 (minutes) on XX day to X2 (hours):X2 (minutes) on XX day. It can indicate that the terminal may be triggered to perform the communication behavior based on the mobility event within the time period, or it may be expressed as a condition of whether a relevant parameter of the terminal within the time period fulfills a condition for a corresponding mobility event so as to trigger the execution of the communication behavior.

In some embodiments, the configuration information includes a hysteresis value for triggering the terminal to perform the communication behavior based on the mobility event.

For example, the configuration information may include the hysteresis value for triggering the terminal to perform the communication behavior based on the mobility event. It can be understood that the hysteresis value is mainly used to make it less likely to trigger the execution of communication behavior when the terminal performs the communication behavior based on the mobility event. For example, assuming that the mobility event is “the velocity of the terminal being greater than the first velocity threshold”, when the velocity of the terminal is greater than the first velocity threshold, the execution of the communication behavior can be triggered. After the hysteresis value is introduced, the terminal may need to fulfill the condition that “a difference between the terminal velocity and the hysteresis value being greater than the first velocity threshold” to perform the communication behavior. Compared with the event without the hysteresis value, after the hysteresis value is introduced, the terminal may need a higher velocity to fulfill the triggering of the communication behavior. It can be understood that the condition threshold for the terminal to perform the communication behavior is raised. In some embodiments, the configuration information includes reporting indication information to fulfill measurement reporting for the mobility event.

For example, the configuration information may include the reporting indication information for fulfilling measurement reporting for the mobility event. The terminal may perform corresponding measurement reporting based on the indication of the reporting indication information.

In the present disclosure, the terminal can be triggered to perform the communication behavior based on the mobility event through various parameters in the configuration information, so that the network device can perform mobile configuration and optimization, thereby reducing the probability of handover failure or radio link failure, and improving the mobility performance of the terminal.

In the communication method provided in an embodiment of the present disclosure, FIG. 5 is a flowchart of another communication method according to an example embodiment. As shown in FIG. 5, performing the communication behavior based on the configuration information in S12 may include the following steps:

In step S31, based on the configuration information, whether the mobility event is fulfilled is determined.

In some embodiments, the terminal may determine whether the mobility event is fulfilled based on the configuration information.

For example, the terminal may determine whether the terminal fulfills the corresponding mobility event in the event type information based on the event type information, the threshold, the time information, the hysteresis value, etc. in the configuration information.

In step S32, in response to the mobility event being fulfilled, the communication behavior is performed; or, in response to the mobility event being not fulfilled, the communication behavior is prohibited.

In some embodiments, the terminal may perform the communication behavior in response to the mobility event being fulfilled. Alternatively, the terminal may prohibit the communication behavior in response to the mobility event being not fulfilled, for example, prohibiting an on-going communication behavior, or prohibiting the communication behavior from being performed during a period when the mobility event is not fulfilled.

In the present disclosure, whether to trigger execution of the communication behavior is determined by determining whether the terminal fulfills the mobility event, so that the network device can dynamically perform mobile configuration and optimization, thereby reducing the probability of handover failure or radio link failure, and improving the mobility performance of the terminal.

In the communication method provided by an embodiment of the present disclosure, the configuration information includes the event type information, the threshold and the hysteresis value, and the mobility event includes the velocity of the terminal being greater than the first velocity threshold. Determining whether the mobility event is fulfilled based on the configuration information includes: in response to a difference between the velocity of the terminal and the hysteresis value being greater than the first velocity threshold, determining that the mobility event is fulfilled; in response to a sum of the velocity of the terminal and the hysteresis value being smaller than the first velocity threshold, determining that the mobility event is not fulfilled.

In some embodiments, the configuration information includes the event type information, the threshold, and the hysteresis value. The mobility event described by the event type information may be that the velocity of the terminal is greater than the first velocity threshold, and the threshold corresponds to the first velocity threshold in the mobility event. The condition for fulfilling the mobility event may be that the difference between the velocity of the terminal and the hysteresis value is greater than the first velocity threshold, for example, the velocity of the terminal−the hysteresis value>the first velocity threshold. This condition may also be considered as an entry condition for the mobility event. The condition for not fulfilling the mobility event may be that the sum of the velocity of the terminal and the hysteresis value is smaller than the first velocity threshold, for example, the velocity of the terminal+the hysteresis value<the first velocity threshold. This condition may also be considered as a leaving condition for the mobility event.

It is understood that the first velocity threshold in the leaving condition may also be replaced by a third velocity threshold different from the first velocity threshold. However, the third velocity threshold should be smaller than the first velocity threshold.

In some embodiments, the velocity of the terminal may be a vertical velocity. The configuration information includes the event type information, the threshold, and the hysteresis value. The mobility event described by the event type information may be that the vertical velocity of the terminal is greater than the first vertical velocity threshold, and the threshold corresponds to the first vertical velocity threshold in the mobility event. The condition for fulfilling the mobility event may be that the difference between the vertical velocity of the terminal and the hysteresis value is greater than the first vertical velocity threshold, for example, the vertical velocity of the terminal-the hysteresis value >the first vertical velocity threshold. This condition may also be considered as the entry condition for the mobility event. The condition for not fulfilling the mobility event may be that the sum of the vertical velocity of the terminal and the hysteresis value is smaller than the first vertical velocity threshold. For example, the vertical velocity of the terminal +the hysteresis value <the first vertical velocity threshold. This condition may also be considered as the leaving condition for the mobility event.

It can be understood that the first vertical velocity threshold in the leaving condition may also be replaced by a third vertical velocity threshold different from the first vertical velocity threshold, but the third vertical velocity threshold should be smaller than the first vertical velocity threshold.

The present disclosure configures the entry and leaving conditions for the mobility event to trigger whether to perform the communication behavior, so that network device can dynamically perform mobile configuration and optimization, thereby reducing the probability of handover failure or radio link failure, and improving the mobility performance of the terminal.

In the communication method provided by an embodiment of the present disclosure, the configuration information includes the event type information, the threshold, and the hysteresis value, and the mobility event includes the velocity of the terminal being smaller than a second velocity threshold. Determining whether the mobility event is fulfilled based on the configuration information includes: in response to a sum of the velocity of the terminal and the hysteresis value being smaller than the second velocity threshold, determining that the mobility event is fulfilled; in response to a difference between the velocity of the terminal and the hysteresis value being greater than the second velocity threshold, determining that the mobility event is not fulfilled.

In some embodiments, the configuration information includes the event type information, the threshold, and the hysteresis value. The mobility event described by the event type information may be that the velocity of the terminal is smaller than the second velocity threshold, and the threshold corresponds to the second velocity threshold in the mobility event. The condition for fulfilling the mobility event may be that the sum of the velocity of the terminal and the hysteresis value is smaller than the second velocity threshold, for example, the velocity of the terminal+the hysteresis value<the second velocity threshold. This condition may also be considered as an entry condition for the mobility event. The condition for not fulfilling the mobility event may be that the difference between the velocity of the terminal and the hysteresis value is greater than the second velocity threshold, for example, the velocity of the terminal−the hysteresis value>the second velocity threshold. This condition may also be considered as a leaving condition for the mobility event.

It is understandable that the second velocity threshold in the leaving condition may also be replaced by a fourth velocity threshold different from the second velocity threshold. However, the fourth velocity threshold should be greater than the second velocity threshold.

In some embodiments, the velocity of the terminal may be a vertical velocity. The configuration information includes the event type information, the threshold, and the hysteresis value. The mobility event described by the event type information may be that the vertical velocity of the terminal is smaller than a second vertical velocity threshold, and the threshold corresponds to the second vertical velocity threshold in the mobility event. The condition for fulfilling the mobility event may be that the sum of the vertical velocity of the terminal and the hysteresis value is smaller than the second vertical velocity threshold, for example, the vertical velocity of the terminal+the hysteresis value<the second vertical velocity threshold. This condition may also be considered as an entry condition for the mobility event. The condition for not fulfilling the mobility event may be that the difference between the vertical velocity of the terminal and the hysteresis value is greater than the second vertical velocity threshold, for example, the vertical velocity of the terminal-the hysteresis value >the second vertical velocity threshold. This condition may also be considered as a leaving condition for the mobility event.

It can be understood that the second vertical velocity threshold in the leaving condition may also be replaced by a fourth vertical velocity threshold that is different from the second vertical velocity threshold, but the fourth vertical velocity threshold should be greater than the second vertical velocity threshold.

The present disclosure configures the entry and leaving conditions for the mobility event to trigger whether to perform the communication behavior, so that network device can dynamically perform mobility configuration and optimization, thereby reducing the probability of handover failure or radio link failure, and improving the mobility performance of the terminal.

In the communication method provided by an embodiment of the present disclosure, the configuration information includes event type information, the threshold and the hysteresis value, and the mobility event includes that a velocity change amount of the terminal is greater than a velocity change amount threshold. Determining whether the mobility event is fulfilled based on the configuration information, includes: in response to a difference between the maximum velocity of the terminal within a first time and the hysteresis value being greater than a sum of the minimum velocity of the terminal within the first time and the velocity change amount threshold, determining that the mobility event is fulfilled; in response to a sum of the maximum velocity of the terminal within a second time and the hysteresis value being smaller than a sum of the minimum velocity of the terminal within the second time and the velocity change amount threshold, determining that the mobility event is not fulfilled.

In some embodiments, the configuration information includes the event type information, the threshold, and the hysteresis value. The mobility event described by the event type information may be that the velocity change amount of the terminal is greater than the velocity change amount threshold, and the threshold corresponds to the velocity change amount threshold in the mobility event. The condition for fulfilling the mobility event may be that the difference between the maximum velocity of the terminal within the first time and the hysteresis value is greater than the sum of the minimum velocity of the terminal within the first time and the velocity change amount threshold, for example, the maximum velocity of the terminal within the first time−the hysteresis value>the minimum velocity of the terminal within the first time+the velocity change amount threshold. This condition may also be considered as an entry condition for the mobility event. The condition for not fulfilling the mobility event may be that the sum of the maximum velocity of the terminal within the second time and the hysteresis value is smaller than the sum of the minimum velocity of the terminal within the second time and the velocity change amount threshold, for example, the maximum velocity of the terminal within the second time+the hysteresis value<the minimum velocity of the terminal within the second time+the velocity change amount threshold. This condition may also be considered as a leaving condition for the mobility event.

The first time and the second time may be the same or different.

It can be understood that the velocity change amount threshold in the entry condition may be a first velocity change amount threshold, and the velocity change amount threshold in the leaving condition may be a second velocity change amount threshold, and the first velocity change amount threshold is greater than the second velocity change amount threshold.

In some embodiments, the velocity of the terminal may be a vertical velocity. The configuration information includes the event type information, the threshold, and the hysteresis value. The mobility event described by the event type information may be that the vertical velocity change amount of the terminal is greater than the vertical velocity change amount threshold, and the threshold corresponds to the vertical velocity change amount threshold in the mobility event. The condition for fulfilling the mobility event may be that the difference between the maximum vertical velocity of the terminal within the first time and the hysteresis value is greater than the sum of the minimum vertical velocity of the terminal within the first time and the vertical velocity change amount threshold, for example, the maximum vertical velocity of the terminal within the first time−the hysteresis value>the minimum vertical velocity of the terminal within the first time+the vertical velocity change amount threshold. This condition may also be considered as an entry condition for the mobility event. The condition for not fulfilling the mobility event may be that the sum of the maximum vertical velocity of the terminal within the second time and the hysteresis value is smaller than the sum of the minimum vertical velocity of the terminal within the second time and the vertical velocity change amount threshold, for example, the maximum vertical velocity of the terminal within the second time+the hysteresis value<the minimum vertical velocity of the terminal within the second time+the vertical velocity change amount threshold. This condition may also be considered as a leaving condition for the mobility event.

It can be understood that the vertical velocity change amount threshold in the entry condition may be a first vertical velocity change amount threshold, and the vertical velocity change amount threshold in the leaving condition may be a second vertical velocity change amount threshold, and the first vertical velocity change amount threshold is greater than the second vertical velocity change amount threshold.

The present disclosure configures the entry and leaving conditions for the mobility event to trigger whether to perform the communication behavior, so that network device can dynamically perform mobility configuration and optimization, thereby reducing the probability of handover failure or radio link failure, and improving the mobility performance of the terminal.

In the communication method provided by an embodiment of the present disclosure, the configuration information includes the event type information, the threshold and the hysteresis value, and the mobility event includes that a height change amount of the terminal is greater than a height change amount threshold. Determining whether the mobility event is fulfilled based on the configuration information, includes: in response to a difference between the maximum height of the terminal within a third time and the hysteresis value being greater than a sum of the minimum height of the terminal within the third time and the height change amount threshold, determining that the mobility event is fulfilled; in response to a sum of the maximum height of the terminal within a fourth time and the hysteresis value being smaller than a sum of the minimum height of the terminal within the fourth time and the height change amount threshold, determining that the mobility event is not fulfilled.

In some embodiments, the configuration information includes the event type information, the threshold, and the hysteresis value. The mobility event described by the event type information may be that the height change amount of the terminal is greater than the height change amount threshold, and the threshold corresponds to the height change amount threshold in the mobility event. The condition for fulfilling the mobility event may be that the difference between the maximum height of the terminal within the third time and the hysteresis value is greater than the sum of the minimum height of the terminal within the third time and the height change amount threshold, for example, the maximum height of the terminal within the third time−the hysteresis value>the minimum height of the terminal within the third time+the height change amount threshold. This condition may also be considered as an entry condition for the mobility event. The condition for not fulfilling the mobility event may be that the sum of the maximum height of the terminal within the fourth time and the hysteresis value is smaller than the sum of the minimum height of the terminal within the fourth time and the height change amount threshold, for example, the maximum height of the terminal within the fourth time+the hysteresis value<the minimum height of the terminal within the fourth time +the height change amount threshold. This condition may also be considered as the leaving condition for the mobility event.

The third time and the fourth time may be the same or different.

It can be understood that the height change amount threshold in the entry condition may be a first height change amount threshold, and the height change amount threshold in the leaving condition may be a second height change amount threshold, and the first height change amount threshold is greater than the second height change amount threshold. The present disclosure configures the entry and leaving conditions for the mobility event to trigger whether to perform the communication behavior, so that network device can dynamically perform mobility configuration and optimization, thereby reducing the probability of handover failure or radio link failure, and improving the mobility performance of the terminal.

In the communication method provided by an embodiment of the present disclosure, the configuration information includes the time information. The first time, the second time, the third time and/or the fourth time are determined based on the time information. In some embodiments, the entry conditions and leaving conditions for some events may involve the first time, the second time, the third time and/or the fourth time, for example, determining the maximum velocity within the first time, the maximum height within the second time, etc. The first time, the second time, the third time and/or the fourth time may be determined based on the time information in the configuration information. For example, if the time information in the configuration information is a time period, the first time, the second time, the third time and/or the fourth time correspond to the time period.

The time information in the configuration information of the present disclosure may be combined with the entry condition or leaving condition for the mobility event to determine whether to trigger the execution of the communication behavior, so that the network device can dynamically perform mobile configuration and optimization, thereby reducing the probability of handover failure or radio link failure, and improving the mobility performance of the terminal.

In the communication method provided by an embodiment of the present disclosure, perform a preset communication behavior may include at least one of: sending a measurement report to the network device; perform a serving cell handover, serving cell addition and/or serving cell change triggered based on the mobility event.

In some embodiments, the communication behavior performed by the terminal may be sending a measurement report to the network device.

For example, when the terminal determines that the entry condition for corresponding mobility information is fulfilled, the terminal may initiate measurement reporting, obtain a measurement report, and send the measurement report to the network device.

In some embodiments, the communication behavior performed by the terminal may be performing a conditional handover, such as a serving cell handover, serving cell addition, and/or serving cell change triggered based on the mobility event.

For example, when the terminal determines that the entry condition for corresponding mobility information is fulfilled, the terminal may perform a serving cell handover. Alternatively, when the terminal determines that the entry condition for corresponding mobility information is fulfilled, the terminal may perform serving cell addition. Alternatively, when the terminal determines that the entry condition for corresponding mobility information is fulfilled, the terminal may perform serving cell change.

In the present disclosure, the execution of multiple different communication behaviors is triggered when mobility event(s) is(are) fulfilled, so that network device can dynamically perform mobility configuration and optimization, thereby reducing the probability of handover failure or radio link failure, and improving the mobility performance of the terminal.

In the communication method provided by an embodiment of the present disclosure, prohibiting the communication behavior may include: removing a corresponding measurement report and/or a measurement configuration stored in the terminal.

In some embodiments, the prohibition of the communication behavior by the terminal may be removing a corresponding measurement report and/or a measurement configuration stored in the terminal.

It can be understood that the measurement configuration may be configuration information for measurement reporting. When the terminal does not fulfill the mobility event, the terminal may remove all information related to the measurement; for example, the measurement configuration and an already stored measurement report may be deleted. After the measurement configuration is deleted, the terminal will not be able to perform measurement reporting. If measurement reporting is needed, the terminal needs to re-obtain a measurement configuration.

In the present disclosure, the terminal is prohibited from performing measurement reporting when the mobility event is not fulfilled, thereby reducing power consumption for the terminal, saving computing resources, and reducing network resource consumption.

In the communication method provided in an embodiment of the present disclosure, FIG. 6 is a flowchart of yet another communication method according to an example embodiment. As shown in FIG. 6, the configuration information includes reporting indication information, and the method may further include the following step(s):

In step S41, when the communication behavior is prohibited, a specified number of measurement report(s) is(are) sent.

In some embodiments, if the configuration information includes the reporting indication information, the terminal may send a measurement report for a specified number of time(s) when the communication behavior is prohibited.

For example, the specified number of time(s) may be once. That is, if the configuration information includes the reporting indication information, the terminal may send a measurement report once when the communication behavior is prohibited. It can be considered that the reporting indication information is mainly used to further perform the measurement reporting for the last specified number of time(s) when the terminal prohibits the communication behavior, or when the terminal does not fulfill the mobility information. This allows the network device to perform mobile configuration and optimization based on the measurement report which is last reported for the specified number of time(s).

Of course, the present disclosure does not limit the specific value of the specified number.

In the present disclosure, when the communication behavior is prohibited, the measurement report may be sent for a specified number of time(s), so that the network device can dynamically perform mobile configuration and optimization, thereby reducing the probability of handover failure or radio link failure, and improving the mobility performance of the terminal.

In the communication method provided by an embodiment of the present disclosure, the measurement report may include at least one of the following parameters: the velocity of the terminal; the height of the terminal; a measurement result of a serving cell; a measurement result of a neighboring cell; or event indication information, wherein the event indication information is used to explicitly or implicitly indicate that the event triggering the measurement report is the mobility event.

In some embodiments, the measurement report may include the velocity of the terminal.

For example, the measurement report may include the vertical velocity of the terminal, the horizontal velocity of the terminal, the maximum velocity of the terminal within a certain time period, the minimum velocity of the terminal within a certain time period, the maximum horizontal velocity of the terminal within a certain time period, the maximum vertical velocity of the terminal within a certain time period, the minimum horizontal velocity of the terminal within a certain time period, the minimum vertical velocity of the terminal within a certain time period, etc.

In some embodiments, the measurement report may include the height of the terminal.

For example, the measurement report may include the height of the terminal, the maximum height of the terminal within a certain time period, the minimum height of the terminal within a certain time period, etc.

In some embodiments, the measurement report may include a measurement result of a serving cell.

For example, the measurement report may include the measurement result of the serving cell. It can be understood that the measurement result of the serving cell may be obtained by measurement when the terminal initiates measurement reporting.

In some embodiments, the measurement report may include a measurement result of a neighboring cell.

For example, the measurement report may include the measurement result of the neighboring cell. It can be understood that the measurement result of the neighboring cell may be obtained by measurement when the terminal initiates measurement reporting.

In some embodiments, the measurement report may include event indication information.

For example, the measurement report may include the event indication information for explicitly or implicitly indicating that the event that triggers the measurement reporting is the mobility event. For example, a preset identity may be used, or the event type information may be directly used as the event indication information. It can be understood that this method is an explicit indication method. For another example, other information may be used for implicit indication. An association relationship between other information and the mobility event may be established in advance. In this way, based on other information, it can be determined that the event that triggers the measurement reporting is the mobility event.

The present disclosure uses the various types of information included in the measurement report to enable the network device to dynamically perform mobile configuration and optimization based on the measurement report, thereby reducing the probability of handover failure or radio link failure, and improving the mobility performance of the terminal.

Based on the same concept, FIG. 7 is a flowchart of another communication method according to an example embodiment. As shown in FIG. 7, the method is applied to a network device. The method may include the following step(s):

In step S51, configuration information is sent.

In some embodiments, the network device may send the configuration information. The configuration information includes information for triggering a terminal to perform a communication behavior based on a mobility event.

For example, the configuration information may be pre-configured in the network device, and the network device may send the pre-configured configuration information to the terminal. Alternatively, the network device may determine the configuration information that needs to be sent, and send the configuration information to the terminal after generating the configuration information. The present disclosure does not limit how the network device obtains the configuration information.

In the present disclosure, the configuration information can be sent, so that the terminal can be triggered to perform the communication behavior based on the mobility event according to the configuration information. Accordingly, the network device can perform mobile configuration and optimization, thereby reducing the probability of handover failure or radio link failure, and improving the mobility performance of the terminal.

In the communication method provided by an embodiment of the present disclosure, the mobility event is a velocity-based mobility event.

In some embodiments, the mobility event that triggers the terminal to perform the communication behavior may be a velocity-based mobility event.

It can be understood that the present disclosure takes into account the impact of velocity on the terminal, and thus a velocity-based mobility event can trigger the terminal to perform the communication behavior.

In the present disclosure, a terminal is triggered to perform the communication behavior in combination with the velocity-based mobility event, so that network device can perform mobile configuration and optimization, thereby reducing the probability of handover failure or radio link failure, and improving the mobility performance of the terminal.

In the communication method provided by an embodiment of the present disclosure, the velocity-based mobility event may include at least one of: a velocity of the terminal being greater than a first velocity threshold; the velocity of the terminal being smaller than a second velocity threshold; a velocity change amount of the terminal being greater than a velocity change amount threshold; or a height change amount of the terminal being greater than a height change amount threshold.

In some embodiments, the velocity-based mobility event may be the velocity of the terminal being greater than the first velocity threshold.

For example, the mobility event involved in the configuration information sent by the network device is the velocity of the terminal being greater than the first velocity threshold. After the terminal receives the configuration information, the terminal may be triggered to perform a communication behavior based on the velocity of the terminal being greater than the first velocity threshold. Of course, the velocity of the terminal may be a vertical velocity or a horizontal velocity.

In some embodiments, the velocity-based mobility event may be the velocity of the terminal being smaller than the second velocity threshold.

For example, the mobility event involved in the configuration information sent by the network device is t the velocity of the terminal being smaller than the second velocity threshold. After the terminal receives the configuration information, the terminal may be triggered to perform a communication behavior based on the velocity of the terminal being smaller than the second velocity threshold. Of course, the velocity of the terminal may be a vertical velocity or a horizontal velocity.

In some embodiments, the velocity-based mobility event may be the velocity change amount of the terminal is greater than the velocity change amount threshold.

For example, the mobility event involved in the configuration information sent by the network device is the velocity change amount of the terminal being greater than the velocity change amount threshold. After the terminal receives the configuration information, the terminal may be triggered to perform a communication behavior based on the velocity change amount of the terminal being greater than the velocity change amount threshold. Of course, the velocity change amount of the terminal may be a vertical velocity change amount or a horizontal velocity change amount.

In some embodiments, the velocity-based mobility event may be the height change amount of the terminal being greater than the height change amount threshold.

For example, the mobility event involved in the configuration information sent by the network device is the height change amount of the terminal being greater than the height change amount threshold. After the terminal receives the configuration information, the terminal may be triggered to perform a communication behavior based on the height change amount of the terminal being greater than the height change amount threshold. It can be understood that the height change amount of the terminal may indirectly reflect the change in terminal velocity. For example, combined with time information, when the height change amount of the terminal is large within a time period, it can be considered that the terminal may descend or rise rapidly. Therefore, the height change amount of the terminal may be used as an implicit indication of the terminal velocity.

The present disclosure provides a variety of different velocity-based mobility events, so that the terminal may be triggered to perform the communication behavior based on the velocity-based mobility event(s) in different scenarios, so that network device can perform mobile configuration and optimization, thereby reducing the probability of handover failure or radio link failure, and improving the mobility performance of the terminal.

In the communication method provided by an embodiment of the present disclosure, the velocity-based mobility event may include at least one of: a vertical velocity of the terminal being greater than a first vertical velocity threshold; the vertical velocity of the terminal being smaller than a second vertical velocity threshold; a vertical velocity change amount of the terminal being greater than a vertical velocity change amount threshold; or a height change amount of the terminal being greater than a height change amount threshold.

In some embodiments, the velocity-based mobility event may be the vertical velocity of the terminal being greater than the first vertical velocity threshold.

For example, the mobility event involved in the configuration information sent by the network device is the vertical velocity of the terminal being greater than the first vertical velocity threshold. After the terminal receives the configuration information, the terminal may be triggered to perform a communication behavior based on the vertical velocity of the terminal being greater than the first vertical velocity threshold.

In some embodiments, the velocity-based mobility event may be the vertical velocity of the terminal being smaller than the second vertical velocity threshold.

For example, the mobility event involved in the configuration information sent by the network device is the vertical velocity of the terminal being smaller than the second vertical velocity threshold. After the terminal receives the configuration information, the terminal may be triggered to perform a communication behavior based on the vertical velocity of the terminal being smaller than the second vertical velocity threshold.

In some embodiments, the velocity-based mobility event may be the vertical velocity change amount of the terminal being greater than the vertical velocity change amount threshold.

For example, the mobility event involved in the configuration information sent by the network device is the vertical velocity change amount of the terminal being greater than the vertical velocity change amount threshold. After the terminal receives the configuration information, the terminal may be triggered to perform a communication behavior based on the vertical velocity change amount of the terminal being greater than the vertical velocity change amount threshold.

In some embodiments, the velocity-based mobility event may be the height change amount of the terminal is greater than the height change amount threshold.

For example, the mobility event involved in the configuration information sent by the network device is the height change amount of the terminal being greater than the height change amount threshold. After the terminal receives the configuration information, the terminal may be triggered to perform the communication behavior based on the height change amount of the terminal being greater than the height change amount threshold.

The present disclosure provides a variety of different mobility events based on the vertical velocity, the terminal can be triggered to perform the communication behavior based on the velocity-based mobility event(s) in different scenarios, so that the network device can perform mobile configuration and optimization, thereby reducing the probability of handover failure or radio link failure, and improving the mobility performance of the terminal.

In the communication method provided by an embodiment of the present disclosure, the configuration information includes at least one of the following information: event type information, where the event type information is used to indicate the mobility event that triggers the terminal to perform the communication behavior; a threshold for triggering the terminal to perform the communication behavior based on the mobility event; time information for triggering the terminal to perform the communication behavior based on the mobility event; a hysteresis value for triggering the terminal to perform the communication behavior based on the mobility event; or reporting indication information for fulfilling measurement reporting for the mobility event.

In some embodiments, the configuration information includes the event type information.

For example, the configuration information may include the event type information to describe the mobility event that triggers the terminal to perform the communication behavior. It is understandable that the event type information may include an event identity, such as event S1, event S2, event S3, and the like. In such a case, it is possible to pre-define which events correspond to different identities. For example, event S1 corresponds to “the velocity of the terminal being greater than the first velocity threshold”, event S2 corresponds to “the velocity of the terminal being smaller than the second velocity threshold”, and the like. Of course, the event type information may also be directly information describing the event, such as “the velocity of the terminal being greater than the first velocity threshold”, “the vertical velocity of the terminal being greater than the first vertical velocity threshold”, and the like.

In some embodiments, the configuration information includes the threshold for triggering the terminal to perform the communication behavior based on the mobility event.

For example, the configuration information may include the threshold for triggering the terminal to perform the communication behavior based on the mobility event. Different mobility events correspond to corresponding thresholds. After receiving the configuration information sent by the network device, the terminal may be triggered to perform the communication behavior when a relationship between a corresponding parameter and a threshold fulfills a condition for a corresponding event. For example, after the terminal receives the configuration information sent by the network device, the threshold in the configuration information is the first velocity threshold, so that the terminal may be triggered to perform the communication behavior when the velocity of the terminal is greater than the first velocity threshold.

In some embodiments, the configuration information includes the time information for triggering the terminal to perform the communication behavior based on the mobility event.

For example, the configuration information may include time information for triggering the terminal to perform the communication behavior based on the mobility event. It is understandable that the time information may be used to describe the time when the terminal is triggered to perform the communication behavior based on the mobility event. For example, the time information is X (hours):X (minutes): on XX day. After the terminal receives the configuration information sent by the network device, the terminal may be triggered to perform the communication behavior based on the mobility event after this time point. Alternatively, the time information is a time period, such as X1 (hours):X1 (minutes) on XX day to X2 (hours):X2 (minutes) on XX day. After the terminal receives the configuration information sent by the network device, the terminal may be triggered to perform the communication behavior based on the mobility event within the time period, or the terminal can determine whether a relevant parameter within the time period fulfills a condition for a corresponding mobility event to trigger the execution of the communication behavior.

In some embodiments, the configuration information includes the hysteresis value for triggering the terminal to perform the communication behavior based on the mobility event.

For example, the configuration information may include the hysteresis value for triggering the terminal to perform the communication behavior based on the mobility event. It can be understood that the hysteresis value is mainly used to make it less likely to trigger the execution of the communication behavior when the terminal performs the communication behavior based on the mobility event. For example, assuming that the mobility event is “the velocity of the terminal being greater than the first velocity threshold”, when the velocity of the terminal is greater than the first velocity threshold, the execution of the communication behavior may be triggered. After the hysteresis value is introduced, the terminal may need to fulfill the condition that “the difference between the terminal velocity and the hysteresis value is greater than the first velocity threshold” to perform communication behavior. Compared with an event without the hysteresis value, after the hysteresis value is introduced, the terminal may need a higher velocity to fulfill triggering of the communication behavior. It can be understood that the condition threshold for the terminal to perform the communication behavior is raised.

In some embodiments, the configuration information includes reporting indication information to fulfill measurement reporting for the mobility event.

For example, the configuration information may include reporting indication information for fulfilling measurement reporting for the mobility event. After receiving the configuration information sent by the network device, the terminal may perform corresponding measurement reporting based on the indication of the reporting indication information.

The configuration information sent by the network device in the present disclosure can set various parameters that trigger the terminal to perform communication based on a mobility event, so that the network device can perform mobile configuration and optimization, thereby reducing the probability of handover failure or radio link failure, and improving the mobility performance of the terminal.

In the communication method provided by an embodiment of the present disclosure, the configuration information is used by the terminal to determine whether the mobility event is fulfilled.

In some embodiments, after receiving the configuration information sent by the network device, the terminal may determine, based on the configuration information, whether the terminal fulfills the mobility information involved in the configuration information.

In the present disclosure, the configuration information is sent, so that the terminal determines whether the mobility event is fulfilled based on the configuration information, and then trigger whether to perform the communication behavior. The network device can dynamically perform mobility configuration and optimization, thereby reducing the probability of handover failure or radio link failure, and improving the mobility performance of the terminal.

In the communication method provided by an embodiment of the present disclosure, the configuration information includes the event type information, the threshold and the hysteresis value, and the mobility event includes the velocity of the terminal being greater than the first velocity threshold. The terminal fulfilling the mobility event includes: a difference between the velocity of the terminal and the hysteresis value being greater than the first velocity threshold. The terminal not fulfilling the mobility event includes: the difference between the velocity of the terminal and the hysteresis value being smaller than the first velocity threshold.

In some embodiments, the configuration information includes the event type information, the threshold, and the hysteresis value. The mobility event described by the event type information may be the velocity of the terminal being greater than the first velocity threshold, and the threshold corresponds to the first velocity threshold in the mobility event. The terminal fulfilling the mobility event may be that the difference between the velocity of the terminal and the hysteresis value is greater than the first velocity threshold, for example, the velocity of the terminal−the hysteresis value>the first velocity threshold. This condition may also be considered as an entry condition for the mobility event. The terminal not fulfilling the mobility event may be that the sum of the velocity of the terminal and the hysteresis value is smaller than the first velocity threshold, for example, the velocity of the terminal+the hysteresis value<the first velocity threshold. This condition may also be considered as a leaving condition for the mobility event.

It is understood that the first velocity threshold in the leaving condition may also be replaced by a third velocity threshold different from the first velocity threshold. However, the third velocity threshold should be smaller than the first velocity threshold.

In some embodiments, the velocity of the terminal may be a vertical velocity. The configuration information includes the event type information, the threshold, and the hysteresis value. The mobility event described by the event type information may be the vertical velocity of the terminal being greater than the first vertical velocity threshold, and the threshold corresponds to the first vertical velocity threshold in the mobility event. The terminal fulfilling the mobility event may be that the difference between the vertical velocity of the terminal and the hysteresis value is greater than the first vertical velocity threshold. For example, the vertical velocity of the terminal−the hysteresis value>the first vertical velocity threshold. This condition may also be considered as an entry condition for the mobility event. The terminal not fulfilling the mobility event may be that the sum of the vertical velocity of the terminal and the hysteresis value is smaller than the first vertical velocity threshold. For example, the vertical velocity of the terminal+the hysteresis value<the first vertical velocity threshold. This condition may also be considered as a leaving condition for the mobility event.

It can be understood that the first vertical velocity threshold in the leaving condition may also be replaced by a third vertical velocity threshold different from the first vertical velocity threshold, but the third vertical velocity threshold should be smaller than the first vertical velocity threshold.

The present disclosure configures the entry and leaving conditions for the mobility events to trigger whether to perform the communication behavior, so that network device can dynamically perform mobility configuration and optimization, thereby reducing the probability of handover failure or radio link failure, and improving the mobility performance of the terminal.

In the communication method provided by an embodiment of the present disclosure, the configuration information includes the event type information, the threshold and the hysteresis value, the mobility event includes the velocity of the terminal being smaller than the second velocity threshold. The terminal fulfilling the mobility event includes: a sum of the velocity of the terminal and the hysteresis value being smaller than the second velocity threshold. The terminal not fulfilling the mobility event includes: the sum of the velocity of the terminal and the hysteresis value being greater than the second velocity threshold.

In some embodiments, the configuration information includes the event type information, the threshold, and the hysteresis value. The mobility event described by the event type information may be the velocity of the terminal being smaller than the second velocity threshold, and the threshold corresponds to the second velocity threshold in the mobility event. The terminal fulfilling the mobility event may be that the sum of the velocity of the terminal and the hysteresis value is smaller than the second velocity threshold, for example, the velocity of the terminal +the hysteresis value <the second velocity threshold. This condition may also be considered as an entry condition for the mobility event. The terminal not fulfilling the mobility event may be that the difference between the velocity of the terminal and the hysteresis value is greater than the second velocity threshold, for example, the velocity of the terminal−the hysteresis value>the second velocity threshold. This condition may also be considered as a leaving condition for the mobility event.

It is understandable that the second velocity threshold in the leaving condition may also be replaced by a fourth velocity threshold different from the second velocity threshold. However, the fourth velocity threshold should be greater than the second velocity threshold.

In some embodiments, the velocity of the terminal may be a vertical velocity. The configuration information includes the event type information, the threshold, and the hysteresis value. The mobility event described by the event type information may be the vertical velocity of the terminal being smaller than the second vertical velocity threshold, and the threshold corresponds to the second vertical velocity threshold in the mobility event. The terminal fulfilling the mobility event may be that the sum of the vertical velocity of the terminal and the hysteresis value is smaller than the second vertical velocity threshold. For example, the vertical velocity of the terminal+the hysteresis value<the second vertical velocity threshold. This condition may also be considered as an entry condition for the mobility event. The terminal not fulfilling the mobility event may be that the difference between the vertical velocity of the terminal and the hysteresis value is greater than the second vertical velocity threshold. For example, the vertical velocity of the terminal−the hysteresis value>the second vertical velocity threshold. This condition may also be considered as a leaving condition for the mobility event.

It can be understood that the second vertical velocity threshold in the leaving condition may also be replaced by a fourth vertical velocity threshold that is different from the second vertical velocity threshold, but the fourth vertical velocity threshold should be greater than the second vertical velocity threshold.

The present disclosure configures the entry and leaving conditions for the mobility event to trigger whether to perform the communication behavior, so that the network device can dynamically perform mobility configuration and optimization, thereby reducing the probability of handover failure or radio link failure, and improving the mobility performance of the terminal.

In the communication method provided by an embodiment of the present disclosure, the configuration information includes the event type information, the threshold and the hysteresis value, and the mobility event includes the velocity change amount of the terminal being greater than the velocity change amount threshold. The terminal fulfilling the mobility event includes: a difference between the maximum velocity of the terminal within a first time and the hysteresis value being greater than a sum of the minimum velocity of the terminal within the first time and the velocity change amount threshold; or, the terminal not fulfilling the mobility event includes: a sum of the maximum velocity of the terminal and the hysteresis value within a second time being smaller than a sum of the minimum velocity of the terminal within the second time and the velocity change amount threshold.

In some embodiments, the configuration information includes the event type information, the threshold, and the hysteresis value. The mobility event described by the event type information may be the velocity change amount of the terminal being greater than the velocity change amount threshold, and the threshold corresponds to the velocity change amount threshold in the mobility event. The terminal fulfilling the mobility event may be that the difference between the maximum velocity of the terminal within the first time and the hysteresis value is greater than the sum of the minimum velocity of the terminal within the first time and the velocity change amount threshold, for example, the maximum velocity of the terminal within the first time−the hysteresis value>the minimum velocity of the terminal within the first time+the velocity change amount threshold. This condition may also be considered as an entry condition for the mobility event. The terminal not fulfilling the mobility event may be that the sum of the maximum velocity of the terminal within the second time and the hysteresis value is smaller than the sum of the minimum velocity of the terminal within the second time and the velocity change amount threshold, for example, the maximum velocity of the terminal within the second time+the hysteresis value<the minimum velocity of the terminal within the second time+the velocity change amount threshold. This condition may also be considered as a leaving condition for the mobility event.

The first time and the second time may be the same or different.

It can be understood that the velocity change amount threshold in the entry condition may be a first velocity change amount threshold, and the velocity change amount threshold in the leaving condition may be a second velocity change amount threshold, and the first velocity change amount threshold is greater than the second velocity change amount threshold.

In some embodiments, the velocity of the terminal may be a vertical velocity. The configuration information includes the event type information, the threshold, and the hysteresis value. The mobility event described by the event type information may be the vertical velocity change amount of the terminal being greater than the vertical velocity change amount threshold, and the threshold corresponds to the vertical velocity change amount threshold in the mobility event. The terminal fulfilling the mobility event may be that the difference between the maximum vertical velocity of the terminal within the first time and the hysteresis value is greater than the sum of the minimum vertical velocity of the terminal within the first time and the vertical velocity change amount threshold, for example, the maximum vertical velocity of the terminal within the first time−the hysteresis value>the minimum vertical velocity of the terminal within the first time+the vertical velocity change amount threshold. This condition may also be considered as an entry condition for the mobility event. The condition for the terminal not fulfilling the mobility event may be that the sum of the maximum vertical velocity of the terminal within the second time and the hysteresis value is smaller than the sum of the minimum vertical velocity of the terminal within the second time and the vertical velocity change amount threshold, for example, the maximum vertical velocity of the terminal within the second time+the hysteresis value<the minimum vertical velocity of the terminal within the second time+the vertical velocity change amount threshold. This condition may also be considered as a leaving condition for the mobility event.

It can be understood that the vertical velocity change amount threshold in the entry condition may be a first vertical velocity change amount threshold, and the vertical velocity change amount threshold in the leaving condition may be a second vertical velocity change amount threshold, and the first vertical velocity change amount threshold is greater than the second vertical velocity change amount threshold.

The present disclosure configures the entry and leaving conditions for the mobility event to trigger whether to perform the communication behavior, so that network device can dynamically perform mobility configuration and optimization, thereby reducing the probability of handover failure or radio link failure, and improving the mobility performance of the terminal.

In the communication method provided by an embodiment of the present disclosure, the configuration information includes the event type information, the threshold and the hysteresis value, and the mobility event includes the height change amount of the terminal being greater than the height change amount threshold. The terminal fulfilling the mobility event includes: a difference between the maximum height of the terminal within a third time and the hysteresis value being greater than a sum of the minimum height of the terminal within the third time and the height change amount threshold. The terminal not fulfilling the mobility event includes a sum of the maximum height of the terminal within a fourth time, the hysteresis value being smaller than the sum of the minimum height of the terminal within the fourth time, and the height change amount threshold.

In some embodiments, the configuration information includes the event type information, the threshold, and the hysteresis value. The mobility event described by the event type information may be the height change amount of the terminal being greater than the height change amount threshold, and the threshold corresponds to the height change amount threshold in the mobility event. The terminal fulfilling the mobility event may be that the difference between the maximum height of the terminal within the third time and the hysteresis value is greater than the sum of the minimum height of the terminal within the third time and the height change amount threshold, for example, the maximum height of the terminal within the third time−the hysteresis value>the minimum height of the terminal within the third time+the height change amount threshold. This condition may also be considered as an entry condition for the mobility event. The terminal not fulfilling the mobility event may be that the sum of the maximum height of the terminal within the fourth time and the hysteresis value is smaller than the sum of the minimum height of the terminal within the fourth time and the height change amount threshold, for example, the maximum height of the terminal within the fourth time+the hysteresis value<the minimum height of the terminal within the fourth time+the height change amount threshold. This condition may also be considered as a leaving condition for the mobility event.

The third time and the fourth time may be the same or different.

It can be understood that the height change amount threshold in the entry condition may be a first height change amount threshold, and the height change amount threshold in the leaving condition may be a second height change amount threshold, and the first height change amount threshold is greater than the second height change amount threshold.

The present disclosure configures the entry and leaving conditions for the mobility event to trigger whether to perform the communication behavior, so that network device can dynamically perform mobility configuration and optimization, thereby reducing the probability of handover failure or radio link failure, and improving the mobility performance of the terminal.

In the communication method provided by an embodiment of the present disclosure, the configuration information includes the time information. The first time, the second time, the third time and/or the fourth time are determined based on the time information. In some embodiments, the entry conditions and leaving conditions for some events may involve the first time, the second time, the third time and/or the fourth time, for example, determining the maximum velocity within the first time, the maximum height within the second time, etc. The first time, the second time, the third time and/or the fourth time may be determined based on the time information in the configuration information. For example, if the time information in the configuration information is a time period, the first time, the second time, the third time and/or the fourth time correspond to the time period.

The time information in the configuration information in the present disclosure may be combined with the entry condition and leaving condition for the mobility event to determine whether to trigger the execution of the communication behavior, so that the network device can dynamically perform mobile configuration and optimization, thereby reducing the probability of handover failure or radio link failure, and improving the mobility performance of the terminal.

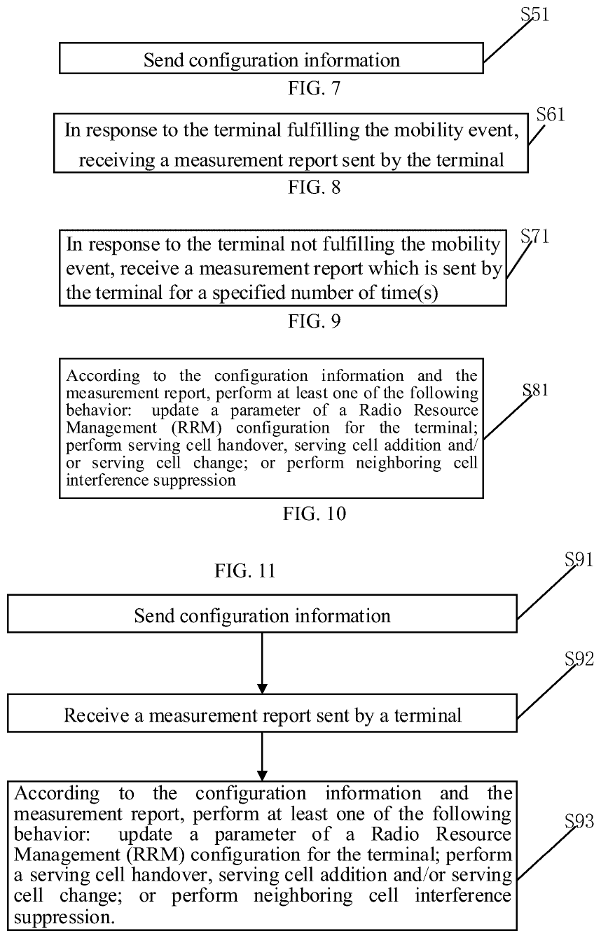

In the communication method provided in an embodiment of the present disclosure, FIG. 8 is a flowchart of yet another communication method according to an example embodiment. As shown in FIG. 8, the method may further include the following step(s):

In step S61, in response to the terminal fulfilling the mobility event, a measurement report sent by the terminal is received.

In some embodiments, the network device may receive a measurement report sent by the terminal when the mobility event is fulfilled.

For example, when the mobility event is fulfilled, the terminal may perform measurement reporting, and the network device may receive the measurement report sent by the terminal, so as to perform mobile configuration and optimization for the terminal.

In the present disclosure, mobile configuration and optimization can be dynamically performed by receiving the measurement report sent by the terminal, thereby reducing the probability of handover failure or radio link failure, and improving the mobility performance of the terminal.

In the communication method provided in an embodiment of the present disclosure, FIG. 9 is a flowchart of yet another communication method according to an example embodiment. As shown in FIG. 9, the configuration information includes reporting indication information, and the method may further include the following step(s):

In step S71, in response to the terminal not fulfilling the mobility event, a measurement report which is sent by the terminal for a specified number of time(s) is received.

In some examples, the network device may receive the measurement report which is sent by the terminal for a specified number of time(s) when the mobility event is not fulfilled.

For example, the specified number of time(s) may be once. For example, if the configuration information includes the reporting indication information, the terminal may send a measurement report once when the communication behavior is prohibited. Of course, the present disclosure does not limit the specific value of the specified number.

In the present disclosure, the network device can receive a measurement report which is sent by the terminal for a specified number of time(s) when the terminal is prohibited from performing the communication behavior, so that the network device can dynamically perform mobile configuration and optimization, thereby reducing the probability of handover failure or radio link failure, and improving the mobility performance of the terminal.

In the communication method provided by an embodiment of the present disclosure, the measurement report may include at least one of the following parameters: the velocity of the terminal; the height of the terminal; a measurement result of a serving cell; a measurement result of a neighboring cell; or event indication information, where the event indication information is used to explicitly or implicitly indicate that the event triggering the measurement reporting is the mobility event.

In some embodiments, the measurement report may include the velocity of the terminal.

For example, the measurement report may include the vertical velocity of the terminal, the horizontal velocity of the terminal, the maximum velocity of the terminal within a certain time period, the minimum velocity of the terminal within a certain time period, the maximum horizontal velocity of the terminal within a certain time period, the maximum vertical velocity of the terminal within a certain time period, the minimum horizontal velocity of the terminal within a certain time period, the minimum vertical velocity of the terminal within a certain time period, etc.

In some embodiments, the measurement report may include the height of the terminal.

For example, the measurement report may include the height of the terminal, the maximum height of the terminal within a certain time period, the minimum height of the terminal within a certain time period, etc.

In some embodiments, the measurement report may include a measurement result of a serving cell.

For example, the measurement report may include the measurement result of the serving cell. It can be understood that the measurement result of the serving cell may be obtained by measurement when the terminal initiates measurement reporting.

In some embodiments, the measurement report may include a measurement result of a neighboring cell.

For example, the measurement report may include the measurement result of the neighboring cell. It can be understood that the measurement result of the neighboring cell may be obtained by measurement when the terminal initiates measurement reporting.

In some embodiments, the measurement report may include the event indication information.

For example, the measurement report may include the event indication information for explicitly or implicitly indicating that the event that triggers the measurement reporting is the mobility event. For example, a preset identity may be used, or the event type information may be directly used as the event indication information. It can be understood that this method is an explicit indication method. For another example, other information may be used for implicit indication. An association relationship between other information and the mobility event may be established in advance. In this way, based on the other information, it can be determined that the event that triggers the measurement reporting is the mobility event.

The present disclosure uses the various types of information included in the measurement report to enable the network device to dynamically perform mobile configuration and optimization based on the measurement report, thereby reducing the probability of handover failure or radio link failure, and improving the mobility performance of the terminal.

In the communication method provided in an embodiment of the present disclosure, FIG. 10 is a flowchart of another communication method according to an example embodiment. As shown in FIG. 10, the method may further include the following step(s):

In step S81, at least one of the following behavior(s) is performed according to the configuration information and the measurement report: updating a parameter of a Radio Resource Management (RRM) configuration of the terminal; performing a serving cell handover, serving cell addition and/or serving cell change; or performing neighbor cell interference suppression.

In some embodiments, the network device may update the parameter of the RRM configuration of the terminal according to the configuration information and the measurement report.

For example, after receiving the measurement report sent by the terminal, the network device may update the parameter of the RRM configuration of the terminal based on the configuration information and the received measurement report.

In some embodiments, the network device may perform a serving cell handover, serving cell addition and/or serving cell change according to the configuration information and the measurement report.

For example, after receiving the measurement report sent by the terminal, the network device may perform a serving cell handover, serving cell addition and/or serving cell change based on the configuration information and the received measurement report.

In some embodiments, the network device may perform neighbor cell interference suppression based on the configuration information and the measurement report.

For example, after receiving the measurement report sent by the terminal, the network device may perform neighboring cell interference suppression based on the configuration information and the received measurement report.

In the present disclosure, the network device can dynamically perform mobile configuration and optimization based on the received measurement report and in combination with configuration information, thereby reducing the probability of handover failure or radio link failure, and improving the mobility performance of the terminal.

FIG. 11 is a flowchart of yet another communication method according to an example embodiment. As shown in FIG. 11, the method is applied to a network device. The method may include the following step(s):

In step S91, configuration information is sent.

In some embodiments, the network device may send the configuration information. The configuration information includes information for triggering a terminal to perform a communication behavior based on a mobility event.

In step S92, a measurement report sent by the terminal is received.

In some embodiments, the network device receives the measurement report sent by the terminal, which may be a measurement report sent by the terminal when the mobility event is fulfilled.

For example, when the mobility event is fulfilled, the terminal may perform measurement reporting, and the network device may receive the measurement report sent by the terminal, so as to perform mobility configuration and optimization for the terminal.

In some examples, the network device receives the measurement report sent by the terminal, which may be a measurement report sent by the terminal for a specified number of time(s) when the mobility event is not fulfilled.

For example, the specified number of time(s) may be once. For example, if the configuration information includes reporting indication information, the terminal may send a measurement report once when the communication behavior is prohibited. Of course, the present disclosure does not limit the specific value of the specified number of time(s).

In step S93, at least one of the following behavior(s) is performed according to the configuration information and the measurement report: updating a parameter of a Radio Resource Management (RRM) configuration of the terminal; performing a serving cell handover, serving cell addition and/or serving cell change; or performing neighbor cell interference suppression.

It can be understood that for the specific implementation procedure of the above steps S91 to S93, reference can be made to the solutions described in FIG. 5 to FIG. 10 above, and the present disclosure will not repeat them here.

The present disclosure can enable a terminal to perform the communication behavior based on the configuration information that triggers the terminal to perform the communication behavior based on the mobility event, so that a network device can perform mobile configuration and optimization, thereby reducing the probability of handover failure or radio link failure, and improving the mobility performance of the terminal.

The present disclosure will hereinafter describe the above-mentioned embodiments in combination with a practical application.

In an implementation, velocity-based measurement reporting event(s) is(are) introduced, for example, including the following event(s):
Event S1: a (vertical) velocity of a UE is greater than a threshold;
Event S2: a (vertical) velocity of the UE is smaller than a threshold;
Event S3: a (vertical) velocity change amount of the UE is greater than a threshold;
Event H3: a height change amount of the UE is greater than a threshold.

The velocity of the UE may be a vertical velocity and/or a horizontal velocity of the UE.

When the terminal fulfills the above event(s), the terminal may send a measurement report to the network device, which can also be used to trigger a conditional handover.

In an implementation, the UE receives configuration information sent by the network device, where the configuration information includes a configuration for measurement reporting based on a (vertical/horizontal) velocity, and the configuration information includes one or more of the following types of information:
event type: event S1, event S2, event S3, . . . ;
a threshold;
a trigger time;
a hysteresis value;
leaving reporting indication.

In an implementation, the configuration information of the network device, the entry conditions and leaving conditions for events S1, S2, and S3 are respectively:
event S1:
the entry condition: UE velocity-the hysteresis value>a threshold8;
the leaving condition: UE velocity +the hysteresis value <the threshold8;
event S2:
the entry condition: UE velocity +the hysteresis value <a threshold9;
the leaving condition: UE velocity-the hysteresis value >the threshold9;
event S3:
the entry condition: the maximum velocity within a given time-the hysteresis value>the minimum velocity within the given time +a threshold10;
the leaving condition: the maximum velocity within a given time+the hysteresis value<the minimum velocity within the given time+the threshold10;
event H3:
the entry condition: the maximum height within a given time-the hysteresis value>the minimum altitude within the given time+a threshold11;
the leaving condition: the maximum altitude within a given time +the hysteresis value<the minimum altitude within a given time+the threshold11.

The given time in event S3 and event H3 may be the trigger time.

It can be understood that the given time may be the first time, the second time, the third time and/or the fourth time mentioned above.

In an implementation, according to the configuration information of the network device, the UE determines whether the UE fulfills an entry condition for a velocity-based measurement reporting event within the trigger time; if yes, the measurement reporting is initiated.

In an implementation, according to the configuration information of the network device, the UE determines whether the UE fulfills a leaving condition for the velocity-based measurement reporting event within the trigger time; if yes, the measurement reporting is stopped and the corresponding measurement reporting information stored in the UE is removed.

Stopping measurement reporting can also be understood as prohibiting measurement reporting.

In an implementation, if the leaving reporting indication is configured, measurement reporting is triggered once when the leaving condition is fulfilled.

In an implementation, when the UE fulfills the velocity-based measurement reporting event, the UE initiates measurement reporting, and sends a measurement report to the network device. The measurement report includes one or more of the following types of information:
the velocity of the UE;
a measurement result of a serving cell;
a measurement result of a neighboring cell; or
indication information that explicitly or implicitly indicates that the event triggering the measurement reporting is the velocity-based measurement reporting event.

In an implementation, when the network device receives the measurement report sent by the UE, the network device updates a parameter of an RRM configuration of the UE according to the configuration corresponding to the event triggering the measurement report and the content of the measurement report, or initiates a handover or performs neighboring cell interference suppression.

In an implementation, the measurement reporting event may also be a trigger event for a conditional handover. When the trigger event for the conditional handover is fulfilled, the UE may perform the conditional handover.

It should be noted that those skilled in the art can understand that the various implementations/embodiments involved in the embodiments of the present disclosure can be used in conjunction with the aforementioned embodiments or can be used independently. Whether used independently or in conjunction with the aforementioned embodiments, the implementation principle is similar. In the implementations of the present disclosure, some embodiments are described as implementations used together. Of course, those skilled in the art can understand that such examples are not intended to impose limitations on the embodiments of the present disclosure.

Based on the same concept, an embodiment of the present disclosure also provides a communication apparatus.

It is understandable that, in order to realize the above function(s), the communication apparatus provided by the embodiment of the present disclosure includes a hardware structure and/or software module(s) corresponding to the respective function(s). In combination with the units and algorithm steps of each example disclosed in the embodiment of the present disclosure, the embodiment of the present disclosure may be implemented in the form of hardware or a combination of hardware and computer software. Whether a function is implemented in the form of hardware or computer software driving the hardware depends on the specific application and design constraints of the technical solution(s). Those skilled in the art can use different methods to implement the described function(s) for each specific application, but such implementation should not be considered as beyond the scope of the technical solution(s) of the embodiments of the present disclosure.

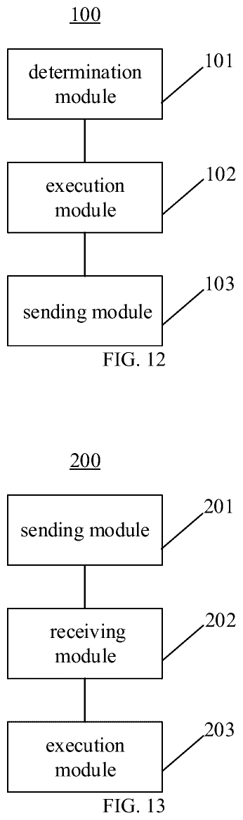

FIG. 12 is a schematic diagram of a communication apparatus according to an example embodiment. Referring to FIG. 12, the apparatus 100 is configured in a terminal, and includes: a determination module 101 configured to determine configuration information, where the configuration information includes information for triggering a terminal to perform a communication behavior based on a mobility event; an execution module 102 configured to perform the communication behavior based on the configuration information.

The present disclosure can enable the terminal to perform the communication behavior based on the configuration information that triggers the terminal to perform the communication behavior based on the mobility event, so that a network device can perform mobile configuration and optimization, thereby reducing the probability of handover failure or radio link failure, and improving the mobility performance of the terminal.

In an embodiment, the mobility event is a velocity-based mobility event.

The present disclosure triggers the terminal to perform the communication behavior in combination with the velocity-based mobility event, so that network device can perform mobile configuration and optimization, thereby reducing the probability of handover failure or radio link failure, and improving the mobility performance of the terminal.

In an embodiment, the velocity-based mobility event includes at least one of: the velocity of the terminal being greater than a first velocity threshold; the velocity of the terminal being smaller than a second velocity threshold; a velocity change amount of the terminal being greater than a velocity change amount threshold; or a height change amount of the terminal being greater than a height change amount threshold.

The present disclosure provides a variety of different types of velocity-based mobility events, so that the terminal may be triggered to perform the communication behavior based on velocity-based mobility event(s) in different scenarios, so that network device can perform mobile configuration and optimization, thereby reducing the probability of handover failure or radio link failure, and improving the mobility performance of the terminal.

In an embodiment, the velocity-based mobility event includes at least one of the following: the vertical velocity of the terminal being greater than a first vertical velocity threshold; the vertical velocity of the terminal being smaller than a second vertical velocity threshold; a vertical velocity change amount of the terminal being greater than a vertical velocity change amount threshold; or a height change amount of the terminal being greater than a height change amount threshold.

The present disclosure provides a variety of different types of mobility events based on the vertical velocity, so that the terminal may be triggered to perform the communication behavior based on the velocity-based mobility event(s) in different scenarios, so that the network device can perform mobile configuration and optimization, thereby reducing the probability of handover failure or radio link failure, and improving the mobility performance of the terminal.

In an implementation, the determination module 101 is further configured to: receive the configuration information sent by the network device.

The present disclosure triggers the terminal to perform the communication behavior based on the mobility event by receiving the configuration information sent by the network device, so that the network device performs mobile configuration and optimization, thereby reducing the probability of handover failure or radio link failure, and improving the mobility performance of the terminal.

In an implementation, the configuration information includes at least one of the following information: event type information, where the event type information is used to indicate the mobility event that triggers the terminal to perform the communication behavior; a threshold for triggering the terminal to perform the communication behavior based on the mobility event; time information for triggering the terminal to perform the communication behavior based on the mobility event; the hysteresis value for triggering the terminal to perform the communication behavior based on the mobility event; or reporting indication information for fulfilling measurement reporting for the mobility event.

The present disclosure can trigger the terminal to perform the communication behavior based on the mobility event through various types of parameters in the configuration information, so that the network device can perform mobile configuration and optimization, thereby reducing the probability of handover failure or radio link failure, and improving the mobility performance of the terminal.

In an implementation, the determination module 101 is further configured to determine whether the mobility event is fulfilled based on the configuration information. The execution module 102 is further configured to perform the communication behavior in response to the mobility event being fulfilled; or to prohibit the communication behavior in response to the mobility event being not fulfilled.

The present disclosure triggers whether to perform the communication behavior by determining whether the terminal fulfills the mobility event, so that the network device can dynamically perform mobility configuration and optimization, thereby reducing the probability of handover failure or radio link failure, and improving the mobility performance of the terminal.

In an implementation, the configuration information includes the event type information, the threshold, and the hysteresis value, and the mobility event includes the velocity of the terminal being greater than the first velocity threshold. The determination module 101 module is further configured to: in response to a difference between the velocity of the terminal and the hysteresis value being greater than the first velocity threshold, determine that the mobility event is fulfilled; in response to a sum of the velocity of the terminal and the hysteresis value being smaller than the first velocity threshold, determine that the mobility event is not fulfilled.

The present disclosure configures the entry and leaving conditions for the mobility event to trigger whether to perform the communication behavior, so that network device can dynamically perform mobility configuration and optimization, thereby reducing the probability of handover failure or radio link failure, and improving the mobility performance of the terminal.

In an implementation, the configuration information includes the event type information, the threshold and the hysteresis value, and the mobility event includes the velocity of the terminal being smaller than the second velocity threshold. The determination module 101 is further configured to: in response to a sum of the velocity of the terminal and the hysteresis value being smaller than the second velocity threshold, determine that the mobility event is fulfilled; in response to the difference between the velocity of the terminal and the hysteresis value being greater than the second velocity threshold, determine that the mobility event is not fulfilled.

The present disclosure configures the entry and leaving conditions for the mobility event to trigger whether to perform the communication behavior, so that network device can dynamically perform mobility configuration and optimization, thereby reducing the probability of handover failure or radio link failure, and improving the mobility performance of the terminal.

In an implementation, the configuration information includes the event type information, the threshold and the hysteresis value, and the mobility event includes the velocity change amount of the terminal being greater than the velocity change amount threshold. The determination module 101 is further configured to: in response to the difference between the maximum velocity of the terminal within the first time and the hysteresis value being greater than the sum of the minimum velocity of the terminal within the first time and the velocity change amount threshold, determine that the mobility event is fulfilled; in response to the sum of the maximum velocity of the terminal within the second time and the hysteresis value being smaller than the sum of the minimum velocity of the terminal within the second time and the velocity change amount threshold, determine that the mobility event is not fulfilled.

The present disclosure configures the entry and leaving conditions for the mobility event to trigger whether to perform the communication behavior, so that network device can dynamically perform mobility configuration and optimization, thereby reducing the probability of handover failure or radio link failure, and improving the mobility performance of the terminal.

In an implementation, the configuration information includes the event type information, the threshold and the hysteresis value, and the mobility event includes the height change amount of the terminal being greater than the height change amount threshold. The determination module 101 is further configured to: in response to the difference between the maximum height of the terminal within the third time and the hysteresis value being greater than the sum of the minimum height of the terminal within the third time and the height change amount threshold, determine that the mobility event is fulfilled; in response to the sum of the maximum height of the terminal within the fourth time and the hysteresis value being smaller than the sum of the minimum height of the terminal within the fourth time and the height change amount threshold, determine that the mobility event is not fulfilled.

The present disclosure configures the entry and leaving conditions for the mobility event to trigger whether to perform the communication behavior, so that network device can dynamically perform mobility configuration and optimization, thereby reducing the probability of handover failure or radio link failure, and improving the mobility performance of the terminal.

In an implementation, the configuration information includes time information; the first time, the second time, the third time and/or the fourth time are determined based on the time information.

In the present disclosure, the time information in the configuration information can be combined with the entry condition and leaving condition for the mobility event to determine whether to trigger the execution of the communication behavior, so that the network device can dynamically perform mobile configuration and optimization, thereby reducing the probability of handover failure or radio link failure, and improving the mobility performance of the terminal.

In an implementation, the apparatus 100 further includes: a sending module 103. The execution module is further configured to perform at least one of the following behavior(s): controlling the sending module to send a measurement report to the network device; performing a serving cell handover, serving cell addition and/or serving cell change triggered based on the mobility event.

The present disclosure triggers the execution of multiple different communication behaviors when the mobility event is fulfilled, so that network device can dynamically perform mobility configuration and optimization, thereby reducing the probability of handover failure or radio link failure, and improving the mobility performance of the terminal.

In an implementation, the execution module 102 is further configured to: remove a corresponding measurement report and/or measurement configuration stored in the terminal.

The present disclosure prohibits the terminal from performing measurement reporting when the mobility event is not fulfilled, thereby reducing power consumption for the terminal, saving computing resources, and reducing network resource consumption.

In an implementation, the configuration information includes reporting indication information, and the apparatus 100 further includes: a sending module 103 configured to send a measurement report for a specified number of time(s) when the communication behavior is prohibited.

In the present disclosure, when the communication behavior is prohibited, a measurement report can be sent for a specified number of time(s), so that the network device can dynamically perform mobile configuration and optimization, thereby reducing the probability of handover failure or radio link failure, and improving the mobility performance of the terminal.

In an implementation, the measurement report includes at least one of the following parameter(s): the velocity of the terminal; the height of the terminal; a measurement result of a serving cell; a measurement result of a neighboring cell; or event indication information, where the event indication information is used to explicitly or implicitly indicate that the event triggering the measurement reporting is the mobility event.

The present disclosure uses the various types of information included in the measurement report to enable the network device to dynamically perform mobile configuration and optimization based on the measurement report, thereby reducing the probability of handover failure or radio link failure, and improving the mobility performance of the terminal.

FIG. 13 is a schematic diagram of another communication apparatus according to an example embodiment. Referring to FIG. 13, an apparatus 200 is configured in a network device, and includes: a sending module 201 configured to send configuration information, where the configuration information includes information for triggering a terminal to perform a communication behavior based on a mobility event.

In the present disclosure, the configuration information can be sent, so that the terminal can be triggered to perform the communication behavior based on the mobility event according to the configuration information. Accordingly, the network device can perform mobile configuration and optimization, thereby reducing the probability of handover failure or radio link failure, and improving the mobility performance of the terminal.

In an implementation, the mobility event is a velocity-based mobility event.

In the present disclosure, the terminal is triggered to perform the communication behavior in combination with the velocity-based mobility event, so that network device can perform mobile configuration and optimization, thereby reducing the probability of handover failure or radio link failure, and improving the mobility performance of the terminal.

In an implementation, the velocity-based mobility event includes at least one of the following: the velocity of the terminal being greater than a first velocity threshold; the velocity of the terminal being smaller than a second velocity threshold; a velocity change amount of the terminal being greater than a velocity change amount threshold; or, a height change amount of the terminal being greater than a height change amount threshold.

The present disclosure provides a variety of different types of velocity-based mobility events, so that the terminal can be triggered to perform the communication behavior based on velocity-based mobility event(s) in different scenarios. Accordingly, the network device can perform mobile configuration and optimization, thereby reducing the probability of handover failure or radio link failure, and improving the mobility performance of the terminal.

In an implementation, the velocity-based mobility event includes at least one of the following: a vertical velocity of the terminal being greater than a first vertical velocity threshold; the vertical velocity of the terminal being smaller than a second vertical velocity threshold; a vertical velocity change amount of the terminal being greater than a vertical velocity change amount threshold; or, a height change amount of the terminal being greater than a height change amount threshold.

The present disclosure provides a variety of different types of mobility events based on the vertical velocity, so that the terminal can be triggered to perform the communication behavior based on the velocity-based mobility event(s) in different scenarios. Accordingly, the network device can perform mobile configuration and optimization, thereby reducing the probability of handover failure or radio link failure, and improving the mobility performance of the terminal.

In an implementation, the configuration information includes at least one of the following information: event type information, where the event type information is used to indicate the mobility event that triggers the terminal to perform the communication behavior; a threshold for triggering the terminal to perform the communication behavior based on the mobility event; time information for triggering the terminal to perform the communication behavior based on the mobility event; a hysteresis value for triggering the terminal to perform the communication behavior based on the mobility event; or, reporting indication information for fulfilling measurement reporting for the mobility event.

In the present disclosure, the configuration information sent by the network device can set various parameters that trigger the terminal to perform communication based on the mobility event, so that the network device can perform mobile configuration and optimization, thereby reducing the probability of handover failure or radio link failure, and improving the mobility performance of the terminal.

In an implementation, the configuration information is used by the terminal to determine whether the mobility event is fulfilled.

In the present disclosure, the configuration information is sent, so that the terminal determines whether the mobility event is fulfilled based on the configuration information, thereby triggering whether to perform a communication behavior. The network device can dynamically perform mobile configuration and optimization, thereby reducing the probability of handover failure or radio link failure, and improving the mobility performance of the terminal.

In an implementation, the configuration information includes the event type information, the threshold and the hysteresis value, the mobility event includes the velocity of the terminal being greater than a first velocity threshold. The terminal fulfilling the mobility event includes: a difference between the velocity of the terminal and the hysteresis value being greater than the first velocity threshold. The terminal not fulfilling the mobility event includes: the difference between the velocity of the terminal and the hysteresis value being smaller than the first velocity threshold.

The present disclosure configures the entry and leaving conditions for the mobility event to trigger whether to perform the communication behavior, so that network device can dynamically perform mobility configuration and optimization, thereby reducing the probability of handover failure or radio link failure, and improving the mobility performance of the terminal.

In an embodiment, the configuration information includes the event type information, the threshold and the hysteresis value, the mobility event includes the velocity of the terminal being smaller than the second velocity threshold. The terminal fulfilling the mobility event includes: a sum of the velocity of the terminal and the hysteresis value being smaller than the second velocity threshold. The terminal not fulfilling the mobility event includes: the sum of the velocity of the terminal and the hysteresis value being greater than the second velocity threshold.

The present disclosure configures the entry and leaving conditions for the mobility event to trigger whether to perform the communication behavior, so that network device can dynamically perform mobility configuration and optimization, thereby reducing the probability of handover failure or radio link failure, and improving the mobility performance of the terminal.

In an implementation, the configuration information includes the event type information, the threshold and the hysteresis value, and the mobility event includes the velocity change amount of the terminal being greater than the velocity change amount threshold. The terminal fulfilling the mobility event includes: the difference between the maximum velocity of the terminal within the first time and the hysteresis value being greater than the sum of the minimum velocity of the terminal within the first time and the velocity change amount threshold; or, the terminal not fulfilling the mobility event includes: the sum of the maximum velocity of the terminal within the second time and the hysteresis value being smaller than the sum of the minimum velocity of the terminal within the second time and the velocity change amount threshold.

The present disclosure configures the entry and leaving conditions for the mobility event to trigger whether to perform the communication behavior, so that network device can dynamically perform mobility configuration and optimization, thereby reducing the probability of handover failure or radio link failure, and improving the mobility performance of the terminal.

In an implementation, the configuration information includes the event type information, the threshold and the hysteresis value, and the mobility event includes the height change amount of the terminal being greater than the height change amount threshold. The terminal fulfilling the mobility event includes: the difference between the maximum height of the terminal within the third time and the hysteresis value being greater than the sum of the minimum height of the terminal within the third time and the height change amount threshold. The terminal not fulfilling the mobility event includes the sum of the maximum height of the terminal within the fourth time, the hysteresis value being smaller than the sum of the minimum height of the terminal within the fourth time, and the height change amount threshold.

The present disclosure configures the entry and leaving conditions for the mobility events to trigger whether to perform the communication behavior, so that network device can dynamically perform mobile configuration and optimization, thereby reducing the probability of handover failure or radio link failure, and improving the mobility performance of the terminal.

In an implementation, the configuration information includes time information; the first time, the second time, the third time and/or the fourth time are determined based on the time information.

In the present disclosure, the time information in the configuration information can be combined with the entry condition and leaving condition for the mobility event to determine whether to trigger the execution of the communication behavior, so that the network device can dynamically perform mobile configuration and optimization, thereby reducing the probability of handover failure or radio link failure, and improving the mobility performance of the terminal.

In an implementation, the apparatus 200 further includes: a receiving module 202 configured to receive a measurement report sent by a terminal in response to the terminal fulfilling a mobility event.

The present disclosure can dynamically perform mobile configuration and optimization by receiving the measurement report sent by the terminal, thereby reducing the probability of handover failure or radio link failure, and improving the mobility performance of the terminal.

In an implementation, the configuration information includes the reporting indication information, and the apparatus 200 further includes: a receiving module 202 configured to receive a measurement report which is sent by the terminal for a specified number of time(s) in response to the terminal not fulfilling the mobility event.

In the present disclosure, the receiving module can receive the measurement report which is sent by the terminal for a specified number of time(s) when terminal is prohibited from performing the communication behavior, so that the network device can dynamically perform mobile configuration and optimization, thereby reducing the probability of handover failure or radio link failure, and improving the mobility performance of the terminal.

In an implementation, the measurement report includes at least one of the following parameter(s): the velocity of the terminal; the height of the terminal; a measurement result of a serving cell; a measurement result of a neighboring cell; or event indication information, where the event indication information is used to explicitly or implicitly indicate that the event triggering the measurement report is the mobility event.

The present disclosure uses the various types of information included in the measurement report to enable the network device to dynamically perform mobile configuration and optimization based on the measurement report, thereby reducing the probability of handover failure or radio link failure, and improving the mobility performance of the terminal.

In an implementation, the apparatus 200 further includes: an execution module 203 configured to perform at least one of the following behavior(s) based on the configuration information and the measurement report: updating a parameter of a Radio Resource Management (RRM) configuration of the terminal; performing a serving cell handover, serving cell addition and/or serving cell change; or performing neighbor cell interference suppression.

In the present disclosure, the network device can dynamically perform mobile configuration and optimization based on the received measurement report and in combination with the configuration information, thereby reducing the probability of handover failure or radio link failure, and improving the mobility performance of the terminal.

Regarding the apparatuses in the above embodiments, the specific manner in which each module performs operation(s) has been described in detail in the embodiments of the methods, and will not be elaborated here.

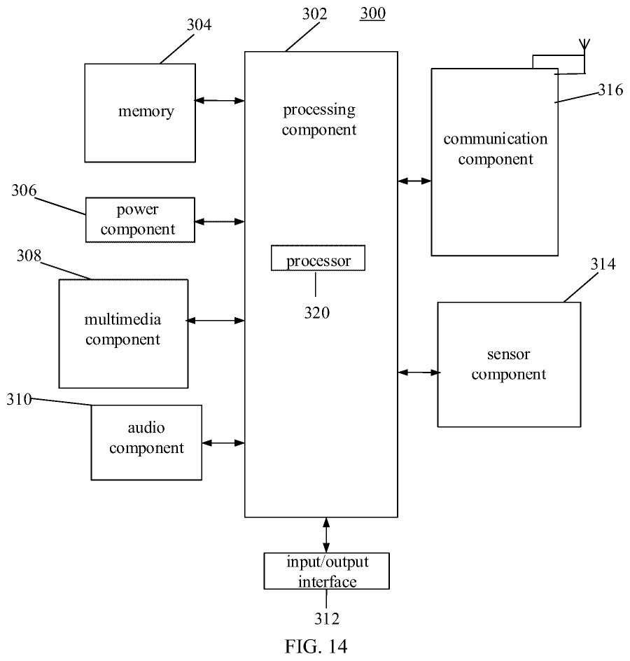

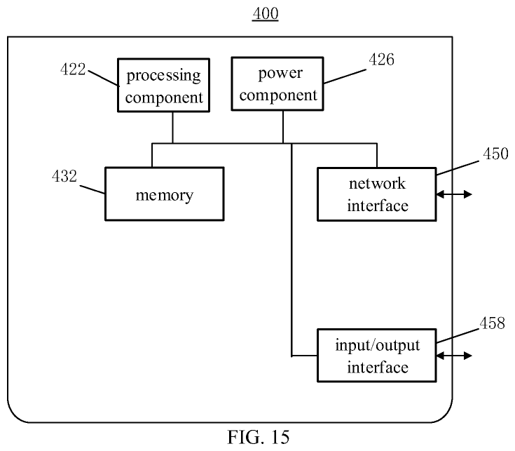

FIG. 14 is a schematic diagram of another apparatus according to an example embodiment. For example, the apparatus 300 may be a mobile phone, a computer, digital broadcast user equipment, a messaging device, a gaming console, a tablet, a medical device, exercise equipment, a personal digital assistant, and the like.

Referring to FIG. 14, the apparatus 300 may include one or more of the following components: a processing component 302, a memory 304, a power component 306, a multimedia component 308, an audio component 310, an input/output (I/O) interface 312, a sensor component 314, and a communication component 316.

The processing component 302 typically controls overall operations of the apparatus 300, such as the operations associated with display, telephone calls, data communications, camera operations, and recording operations. The processing component 302 may include one or more processors 320 to execute instructions to perform all or part of the steps in the above described methods. Moreover, the processing component 302 may include one or more modules which facilitate the interaction between the processing component 302 and other components. For instance, the processing component 302 may include a multimedia module to facilitate the interaction between the multimedia component 308 and the processing component 302.

The memory 304 is configured to store various types of data to support the operation of the apparatus 300. Examples of such data include instructions for any applications or methods operated on the apparatus 300, contact data, phonebook data, messages, pictures, video, etc. The memory 304 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 306 provides power to various components of the apparatus 300. The power component 306 may include a power management system, one or more power sources, and any other components associated with generating, managing, and distributing power in the apparatus 300.

The multimedia component 308 includes a screen providing an output interface between the apparatus 300 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 308 includes a front camera and/or a rear camera. The front camera and the rear camera may receive an external multimedia datum while the apparatus 300 is in an operation mode, such as a photographing mode or a video mode. Each of the front camera and the rear camera may be a fixed optical lens system or have focus and optical zoom capability.

The audio component 310 is configured to output and/or input audio signals. For example, the audio component 310 includes a microphone (“MIC”) configured to receive an external audio signal when the apparatus 300 is in an operation mode, such as a call mode, a recording mode, and a voice recognition mode. The received audio signal may be further stored in the memory 304 or transmitted via the communication component 316. In some embodiments, the audio component 310 further includes a speaker to output audio signals.

The I/O interface 312 provides an interface between the processing component 302 and peripheral interface modules, such as a keyboard, a click wheel, buttons, and the like. The buttons may include, but are not limited to, a home button, a volume button, a starting button, and a locking button.

The sensor component 314 includes one or more sensors to provide status assessments of various aspects of the apparatus 300. For instance, the sensor component 314 may detect an open/closed status of the apparatus 300, relative positioning of components, e.g., the display and the keypad, of the apparatus 300, a change in position of the apparatus 300 or a component of the apparatus 300, a presence or absence of user contact with the apparatus 300, an orientation or an acceleration/deceleration of the apparatus 300, and a change in temperature of the apparatus 300. The sensor component 314 may include a proximity sensor configured to detect the presence of nearby objects without any physical contact. The sensor component 314 may also include a light sensor, such as a CMOS or CCD image sensor, for use in imaging applications. In some embodiments, the sensor component 314 may also include an accelerometer sensor, a gyroscope sensor, a magnetic sensor, a pressure sensor, or a temperature sensor.

The communication component 316 is configured to facilitate communication, wired or wirelessly, between the apparatus 300 and other devices. The apparatus 300 can access a wireless network based on a communication standard, such as WiFi, 2G, or 3G, or a combination thereof. In one example embodiment, the communication component 316 receives a broadcast signal or broadcast associated information from an external broadcast management system via a broadcast channel. In one example embodiment, the communication component 316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the apparatus 300 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer-readable storage medium including instructions, such as the memory 304 including instructions executable by the processor 320 in the apparatus 300, for performing the above-described methods. For example, the non-transitory computer-readable storage medium may be a ROM, a Random Access Memory (RAM), a CD-ROM, a magnetic tape, a floppy disc, an optical data storage device, and the like.

FIG. 15 is a schematic diagram of yet another communication apparatus according to an example embodiment of the present disclosure. For example, the apparatus 400 may be provided as a base station, or a server. Referring to FIG. 15, the apparatus 400 includes a processing component 422 that further includes one or more processors, and memory resources represented by a memory 432 for storing instructions executable by the processing component 422, such as application programs. The application programs stored in the memory 432 may include one or more modules each corresponding to a set of instructions. Further, the processing component 422 is configured to execute the instructions to perform the above described methods.

The apparatus 400 may also include a power component 426 configured to perform power management of the apparatus 400, wired or wireless network interface(s) 450 configured to connect the apparatus 400 to a network, and an input/output (I/O) interface 458. The apparatus 400 may operate based on an operating system stored in the memory 432, such as Windows Server™, Mac OS X™, Unix™, Linux™, FreeBSD™, or the like.

In the present disclosure, measurement reporting is triggered or a conditional handover is performed when the movement velocity of the terminal is greater than or smaller than a certain threshold. According to a measurement result of the terminal at a corresponding movement velocity, the network device can perform mobile configuration and optimization, as well as interference suppression, thereby reducing the probability of HOF or RLF, and improving the mobility performance of the terminal.

It is further understood that in the present disclosure, “a plurality” refers to two or more than two, and other quantifiers are similar. The expression “and/or” describes an association relationship of associated objects, indicating that three relationships may exist. For example, A and/or B can represent: A exists alone, A and B exist at the same time, and B exists alone. The character “/” generally indicates that the associated objects before and after the character are in an “or” relationship. The singular forms “a/an”, “said” and “the” are also intended to include a plural form, unless the context clearly indicates other meanings.

It is further understood that the terms “first”, “second”, etc. are used to describe various information, but such information should not be limited to these terms. These terms are only used to distinguish the same type of information from each other and do not indicate a specific order or degree of importance. In fact, the expressions “first”, “second”, etc. can be used interchangeably. For example, without departing from the scope of the present disclosure, first information may also be referred to as second information, and similarly, the second information may also be referred to as the first information. It is further understood that the meaning of the words “in response to”, “if” involved in the present disclosure depends on the context and the actual usage scenario. For example, the word “in response to” used herein can be interpreted as “when” or “in a case where” or “if”.

It can be further understood that, although the operations are described in a specific order in the drawings in the embodiments of the present disclosure, it should not be understood as requiring the operations to be performed in the specific order shown in the drawings or in a serial order, or requiring the execution of all the operations shown in the drawings to obtain the desired result(s). In certain environments, multitasking and parallel processing may be advantageous.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

1. A method for wireless communication performed by a terminal, the method comprising:
determining configuration information, wherein the configuration information comprises information for triggering the terminal to perform a communication behavior based on a mobility event; and
based on the configuration information, performing the communication behavior;
wherein the mobility event is a velocity-based mobility event.

2. (canceled)

3. The method according to claim 1, wherein the velocity-based mobility event comprises at least one of:
a velocity of the terminal being greater than a first velocity threshold;
the velocity of the terminal being smaller than a second velocity threshold;
a velocity change amount of the terminal being greater than a velocity change amount threshold; or
a height change amount of the terminal being greater than a height change amount threshold; or
wherein the velocity-based mobility event comprises at least one of:
a vertical velocity of the terminal being greater than a first vertical velocity threshold;
a vertical velocity of the terminal being smaller than a second vertical velocity threshold;
a vertical velocity change amount of the terminal being greater than a vertical velocity change amount threshold; or
a height change amount of the terminal being greater than the height change amount threshold.

4. (canceled)

5. The method according to claim 1, wherein determining the configuration information comprises:
receiving the configuration information sent by a network device.

6. The method according to claim 1, wherein the configuration information comprises at least one of:
event type information, wherein the event type information is used to indicate the mobility event that triggers the terminal to perform the communication behavior;
a threshold for triggering the terminal to perform the communication behavior based on the mobility event;
time information for triggering the terminal to perform the communication behavior based on the mobility event;
a hysteresis value for triggering the terminal to perform the communication behavior based on the mobility event; or
reporting indication information for indicating measurement reporting in response to a leaving condition for the mobility event being fulfilled.

7. The method according to claim 6, wherein performing the communication behavior based on the configuration information comprises:
determining whether the mobility event is fulfilled based on the configuration information;
in response to the mobility event being fulfilled, performing the communication behavior; or
in response to the mobility event being not fulfilled, prohibiting the communication behavior.

8.-11. (canceled)

12. The method according to claim 1, wherein the configuration information comprises time information, and at least one of first time, second time, third time, or fourth time are determined based on the time information.

13. The method according to claim 1, wherein performing the communication behavior comprises at least one of:
sending a measurement report to a network device;
performing at least one of a serving cell handover, serving cell addition or serving cell change triggered by the mobility event.

14. The method according to claim 7, wherein prohibiting the communication behavior comprises:
removing at least one of a corresponding measurement report or a measurement configuration stored in the terminal.

15. (canceled)

16. The method according to claim 13, wherein the measurement report comprises at least one of a velocity of the terminal;
a height of the terminal;
a measurement result of a serving cell;
a measurement result of a neighboring cell; or
event indication information, wherein the event indication information is used to explicitly or implicitly indicate that an event triggering measurement reporting is the mobility event.

17. A method for wireless communication, performed by a network device, the method comprising:
sending configuration information, wherein the configuration information comprises information for triggering a terminal to perform a communication behavior based on a mobility event;
wherein the mobility event is a velocity-based mobility event.

18. (canceled)

19. The method according to claim 17, wherein the velocity-based mobility event comprises at least one of:
a velocity of the terminal being greater than a first velocity threshold;
a velocity of the terminal being smaller than a second velocity threshold;
a velocity change amount of the terminal being greater than a velocity change amount threshold; or
a height change amount of the terminal being greater than a height change amount threshold; or
wherein the velocity-based mobility event comprises at least one of:
a vertical velocity of the terminal being greater than a first vertical velocity threshold;
a vertical velocity of the terminal being smaller than a second vertical velocity threshold;
a vertical velocity change amount of the terminal being greater than a vertical velocity change amount threshold; or
a height change amount of the terminal being greater than athe height change amount threshold.

20. (canceled)

21. The method according to claim 17, wherein the configuration information comprises at least one of:
event type information, wherein the event type information is used to indicate the mobility event that triggers the terminal to perform the communication behavior;
a threshold for triggering the terminal to perform the communication behavior based on the mobility event;
time information for triggering the terminal to perform the communication behavior based on the mobility event;
a hysteresis value for triggering the terminal to perform the communication behavior based on the mobility event; or
reporting indication information for indicating measurement reporting in response to a leaving condition for the mobility event being fulfilled.

22. The method according to claim 21, wherein the configuration information is used by the terminal to determine whether the mobility event is fulfilled.

23.-28. (canceled)

29. The method according to claim 22, wherein the configuration information comprises the reporting indication information, and the method further comprises:
in response to the terminal not fulfilling the mobility event, receiving a measurement report which is sent by the terminal for a specified number of times.

30. The method according to claim 29, wherein the measurement report comprises at least one of:
a velocity of the terminal;
a height of the terminal;
a measurement result of a serving cell;
a measurement result of a neighboring cell; or
event indication information, wherein the event indication information is used to explicitly or implicitly indicate that an event triggering measurement reporting is the mobility event.

31. The method according to claim 22, further comprising:
according to the configuration information and the measurement report, performing at least one of the following behavior:
updating a parameter of a Radio Resource Management (RRM) configuration for the terminal;
performing a serving cell handover, serving cell addition and/or serving cell change; or
performing neighboring cell interference suppression.

32.-33. (canceled)

34. A terminal, comprising:
a processor; and
a memory configured to store instructions executable by the processor;
wherein the processor is configured to:
determine configuration information, wherein the configuration information comprises information for triggering the terminal to perform a communication behavior based on a mobility event; and
based on the configuration information, perform the communication behavior;
wherein the mobility event is a velocity-based mobility event.

35. A network device, comprising:
a processor; and
a memory configured to store instructions executable by the processor;
wherein the instructions when executed by the processor cause the communication device to act as the network device and perform the method to claim 17.

36. A non-transitory computer-readable storage medium storing instructions, the instructions when executed by a processor of the terminal, cause the terminal to perform the method according to claim 1.

37. A non-transitory computer-readable storage medium storing instructions, the instruction when executed by a processor of the network device, cause the network device is caused to perform the method according to claim 17.
